(19) United States
(12) Patent Application Publication
(10) Pub. No.: US 2023/0038824 A1
(43) Pub. Date: Feb. 9, 2023

(54) EFFICIENT RUNTIME EVALUATION REPRESENTATION, EXTERNAL CONSTRUCT LATE-BINDING, AND UPDATING MECHANISMS FOR ROUTING POLICIES

(71) Applicant: Arista Networks, Inc., Santa Clara, CA (US)

(72) Inventors: Satish Kumar Mahadevan, San Ramon, CA (US); Matthieu Loriol, Vancouver (CA); Sharad Birmiwal, Surrey (CA); Akshay Gattani, Sunnyvale, CA (US); Keon Vafai, Milpitas, CA (US)

(21) Appl. No.: 17/392,519

(22) Filed: Aug. 3, 2021

(51) Int. Cl. H04L 12/721

(52) U.S. Cl. CPC H04L 45/12; H04L 45/70

(57) ABSTRACT

Novel mechanisms for compiling routing policies and evaluating network routes, including: (a) an efficient mechanism for representing routing policies to facilitate the runtime evaluation of network routes; (b) a mechanism for late-binding vectors pertaining to external constructs used or recited within the routing policies; and (c) a mechanism for updating routing policy state pertinent to network route evaluation. Existing methods for evaluating network routes on a network device, such as the use of route maps, tend to introduce complexity and extend route evaluation runtime when performing, for example, certain operations to one or more route attributes for any given network route being evaluated. Through implementation of disclosed mechanisms, however, route evaluation runtimes may be reduced, thereby minimizing, if not eliminating, any route evaluation congestion.

### BACKGROUND

Existing methods for evaluating network routes on a network device, such as the use of route maps, tend to introduce complexity and extend route evaluation runtime when performing, for example, certain operations to one or more route attributes for any given network route being evaluated.

### BRIEF DESCRIPTION OF DRAWINGS

FIG. 1 shows a network device in accordance with one or more embodiments of the disclosure.

FIG. 2A shows a routing policy agent in accordance with one or more embodiments of the disclosure.

FIG. 2B shows a tree mounting object in accordance with one or more embodiments of the disclosure.

FIG. 3A shows a used external construct key vector in accordance with one or more embodiments of the disclosure.

FIG. 3B shows a used external construct value vector in accordance with one or more embodiments of the disclosure.

FIG. 3C shows a context data object in accordance with one or more embodiments of the disclosure.

FIGS. 4A and 4B show flowcharts describing a method for generating a new state list in accordance with one or more embodiments of the disclosure.

FIG. 5 shows a flowchart describing a method for deriving a collection of data structures in accordance with one or more embodiments of the disclosure.

FIG. 6 shows a flowchart describing a method for updating a tree mounting object in accordance with one or more embodiments of the disclosure.

FIGS. 7A and 7B show flowcharts describing a method for route evaluation in accordance with one or more embodiments of the disclosure.

FIG. 8A shows an exemplary routing policy code in accordance with one or more embodiments of the disclosure.

FIG. 8B shows an exemplary abstract evaluation tree in accordance with one or more embodiments of the disclosure.

FIG. 8C shows an exemplary used route attribute list in accordance with one or more embodiments of the disclosure.

FIG. 8D shows exemplary used external construct key vectors in accordance with one or more embodiments of the disclosure.

FIG. 8E shows exemplary used external construct value vectors in accordance with one or more embodiments of the disclosure.

FIG. 8F shows an exemplary abstract evaluation tree in accordance with one or more embodiments of the disclosure.

FIG. 8G shows an exemplary used route attribute list in accordance with one or more embodiments of the disclosure.

FIG. 8H shows exemplary used external construct key vectors in accordance with one or more embodiments of the disclosure.

FIG. 8I shows exemplary used external construct value vectors in accordance with one or more embodiments of the disclosure.

### DETAILED DESCRIPTION

Specific embodiments will now be described with reference to the accompanying figures.

In general, embodiments of the disclosure relate to novel mechanisms for compiling routing policies and evaluating network routes, including: (a) an efficient mechanism for representing routing policies to facilitate the runtime evaluation of network routes; (b) a mechanism for late-binding vectors pertaining to external constructs used or recited within the routing policies; and (c) a mechanism for updating routing policy state pertinent to network route evaluation. Existing methods for evaluating network routes on a network device, such as the use of route maps, tend to introduce complexity and extend route evaluation runtime when performing, for example, certain operations to one or more route attributes for any given network route being evaluated. Through implementation of disclosed mechanisms, however, route evaluation runtimes may be reduced, thereby minimizing, if not eliminating, any route evaluation congestion.

In one embodiment of the disclosure, one of the above-mentioned mechanisms, described hereinafter, is an abstract evaluation tree. An abstract evaluation tree may refer to a hierarchical structure that serves as an efficient representation, for the runtime evaluation of network routes, of a given routing policy function of a routing policy. To achieve efficient (or fast) network route evaluations at their runtime, certain procedures exhibited in existing network route evaluations, which are known to bottleneck or congest said network route evaluations at runtime, must be addressed. These certain procedures may include, but are not limited to: the compilation of high-level code into computer readable byte-code as well as the subsequent interpretation of the byte-code at the runtime of a network route evaluation; and the performance of demuxing checks to the evaluation path at runtime—e.g., the application of an operation to a network route attribute, which would require checking what the operator is and then enacting the corresponding operation at runtime. Through the use of an abstract evaluation tree, these certain procedures can be avoided at the runtime of any network route evaluation by instead performing them beforehand at the creation time of the abstract evaluation tree and, thereby, allowing for the expedited evaluation of operations at runtime.

In one embodiment of the disclosure, one of the above-mentioned mechanisms, described hereinafter, is the efficient late-binding of external constructs during the runtime evaluation of network routes. An external construct, may refer to a data object employed in the configuration of network protocol route filtering. Examples of an external construct may include, but are not limited to, a prefix list, a community list, an autonomous system (AS)-path access list, an extended-community list, and a large-community list. Binding, on the other hand, may generally refer to the association of a variable name for a variable (e.g., an external construct) to a corresponding variable value, of the variable, maintained in an allocated storage location. Through conventional (i.e., non-late) binding, a variable value pre-exists in storage when the variable name, referencing the variable value, undergoes interpretation and resolution during runtime. Accordingly, any variable configured in such a manner may be referred to as a bound variable, where resolution of the variable name at runtime leads to the retrieval of the corresponding, pre-stored variable value. Conversely, an unbound variable may represent a variable where the variable name has yet to be assigned (or associated with) a corresponding variable value.

Conventional binding, however, raises a challenge when evaluating network routes using abstract evaluation trees that reference external constructs. Specifically, because any external construct(s) is/are configured independently of the network route evaluation runtime, interpretation of said external construct(s), during runtime, would involve time- and resource-expensive lookup operations based on the external construct name(s). In addition to these lookup operations, resolution of the external construct name(s), during evaluation runtime, would require the creation of an abstract evaluation tree clone for each abstract evaluation tree applied in the evaluation of a network route. The abstract evaluation tree clone(s), in turn, would subsequently include node(s) reflective of unbound external construct(s), which would need to be resolved through said expensive lookup operations while the abstract evaluation tree clone(s) is/are used during a network route evaluation.

The solution to the above-mentioned issues involves the application of external construct late-binding, which facilitates the resolution of external construct name(s), efficiently during evaluation runtime, without the need to create any abstract evaluation tree clone(s). Implementation of the said late-binding may entail, for each unbound external construct recited in one or more policy functions of a network routing policy: compiling code, respective to the policy function(s), to create an abstract evaluation tree per policy function, where an external construct name—for the unbound external construct—may be embedded in node(s) of the abstract evaluation tree(s); populating, also during the compilation of the policy function code, a data structure mapping each unique external construct name, embedded in the created abstract evaluation tree(s), to a uniquely generated integer value (or index); when preparing to evaluate a network route, creating a separate data structure that maps each unique index to an external construct value, corresponding to a unique external construct name, of a now bound external construct; and, at runtime of the network evaluation, performing an efficient direct-indexed access of the separate data structure using the unique index (indices) to retrieve the respective external construct value(s).

In one embodiment of the disclosure, one of the above-mentioned mechanisms, described hereinafter, is the minimal re-evaluation of network routes, using one or more abstract evaluation trees, in response to routing policy changes. Specifically, with any number of modifications to a network routing policy, it is entirely possible that the change(s) do(es) not apply to all routing policy function(s) thereof, but rather a select subset. Further, through compilation of the code, respective to the network routing policy, determination of which routing policy function(s) experience change cannot be known since prior state is not tracked. Accordingly, when changes are made to a network routing policy, compilation of the pertaining code may lead to the generation of a new abstract evaluation tree for each routing policy function of the network routing policy.

The above-mentioned result, as it stands and in turn, would consume extensive network device resources as the entire network routing policy (rather than just the routing policy function(s) that exhibited the change(s) thereof) would have to be re-applied to any and all network route(s) which may have been previously evaluated using the network routing policy. To avoid this churn, and thereby ensure that the network route(s) is/are re-evaluated using only the modified routing policy function(s), a deep comparison between abstract evaluation trees is introduced and employed. Particularly, a deep comparison may be applied between a new abstract evaluation tree, created following the compilation of network routing policy code that incorporates one or more modifications, and an existing abstract evaluation tree, corresponding to the network routing policy state prior to incorporation of the modification(s). Further, for a new abstract evaluation tree and a corresponding existing abstract evaluation tree, both representative of a given routing policy function of the network routing policy, the deep comparison may determine whether the two abstract evaluation trees are structurally identical (e.g., have the same expressions in the same order, including calling the same downstream routing policy function(s), etc.). Even the smallest set of routing policy functions, affected by way of modifications to the network routing policy code, which may be either directly modified due to the changes or indirectly modified through the modification of a called routing policy function therein, can be detected through the deep comparison.

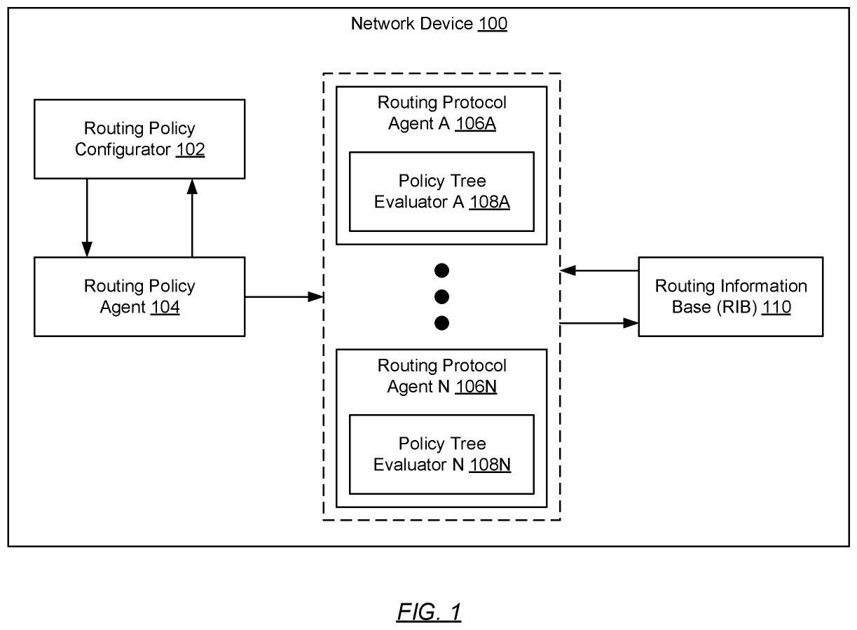

FIG. 1 shows a network device in accordance with one or more embodiments of the disclosure. The network device (100) may include, but is not limited to, a routing policy configurator (102), a routing policy agent (104), any number of routing protocol agents (106A-106N), and a routing information base (RIB) (110). Each of these network device (100) components is described below.

In one embodiment of the disclosure, the network device (100) may represent a physical device that includes and/or is operatively connected to persistent storage (not shown), memory (e.g., random access memory (RAM)) (not shown), one or more computer processors (e.g., integrated circuitry) (not shown), and at least one physical network interface (not shown) (which may also be referred to as a port), which may provide connections (i.e., links) to other devices (e.g., computing devices or end points, other network devices, etc.). The network device (100) may also include any number of additional components (not shown), such as, for example, network chips, field programmable gate arrays (FPGAs), application specific integrated circuits (ASICs), indicator lights (not shown), fans (not shown), etc. In another embodiment of the disclosure, the network device (100) may represent a virtual instance of a network device. In such an embodiment, the network device (100) may, for example, represent a virtual instance of a router that executes within a hypervisor that may be itself executing using underlying physical hardware.

In one embodiment of the disclosure, the network device (100) may include any software configured to perform various functions of the network device (100). Such software may, for example, execute using one or more computer processors of the network device (100), or any other hardware resource of the network device (100) capable of executing software. One example of such software may be an operating system (OS) (not shown). An OS may include any software and/or firmware for managing the resources (e.g., hardware, other software, etc.) of the network device (100). More specifically, an OS may represent a computer program, or a set of computer programs, which manage(s) all or any portion of the other software (e.g., applications, agents, utilities, etc.) on the network device (100), as well as all or any portion of the hardware thereon. Management by an OS may include, but is not limited to, scheduling, hardware allocation, application execution, network access, and file system implementation and data access. An OS may also manage and enforce settings and permissions customized for specific applications running within the OS. Further, an OS may provide an environment in which agents (described below) may execute.

Examples of the network device (100) may include, but are not limited to, a network switch, a router, a multilayer switch, a fibre channel device, and an InfiniBand® device. Further, the network device (100) is not limited to the aforementioned specific examples.

In one embodiment of the disclosure, the network device (100) may include functionality to receive network traffic data units (e.g., frames, packets, tunneling protocol frames, etc.) at any of the network interfaces (i.e., ports) of the network device (100) and to process the network traffic data units. Processing a network traffic data unit may include, but is not limited to, a series of one or more table lookups (e.g., longest prefix match (LPM) lookups, forwarding equivalence class (FEC) looks, etc.) and corresponding actions (e.g., forward from a certain egress port, add a labeling protocol header, rewrite a destination address, encapsulate, etc.). Such a series of lookups and corresponding actions may be referred to as a pipeline, and may be, for example, programmed as a match-action pipeline. Examples of pipeline processing may include, but are not limited to, performing a lookup to determine: (i) whether to take a security action (e.g., drop the network traffic data unit); (ii) whether to mirror the network traffic data unit; and/or (iii) how to route/forward the network traffic data unit in order to transmit the network traffic data unit from an interface of the network device (100).

In one embodiment of the disclosure, the network device (100) may be part of a network (not shown). A network may refer to an entire network or any portion thereof (e.g., a logical portion of the devices within a topology of devices). A network may include a data center network, a local area network (LAN), a wide area network (WAN), a wireless network, a cellular phone network, or any other suitable network that facilitates the exchange of information from one part of the network to another. Further, a network may couple with or overlap, at least in part, with the Internet. A network may include a collection of devices (e.g., including the network device (100)), which collectively facilitate network connectivity for one or more operatively connected end points (e.g., computing devices, data storage devices, etc.) (not shown). Moreover, the network device (100) and other devices within a network may be arranged in a network topology (not shown), where a network topology refers to an arrangement of various devices within a network.

In one embodiment of the disclosure, the persistent storage and/or memory of the network device (100) may refer to, or include, one or more data repositories for storing any number of data structures that store any amount of data (i.e., information). A data repository may represent any type of storage unit and/or device (e.g., a file system, a database, a collection of tables, RAM, and/or any other storage mechanism) for storing data. Further, a data repository may include multiple different storage units and/or devices—each of which may or may not be of the same type or located at the same physical location.

In one embodiment of the disclosure, the persistent storage and/or memory of the network device (100) may be considered, in whole or in part, as non-transitory computer readable media, which store, at least in part, software and/or firmware.

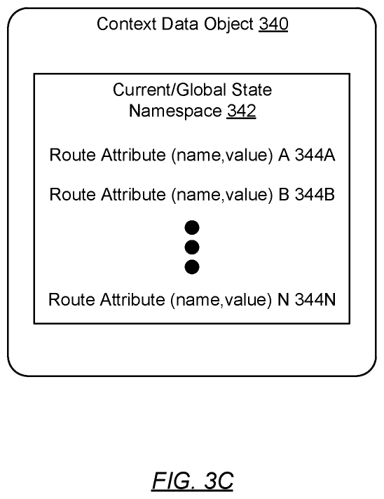

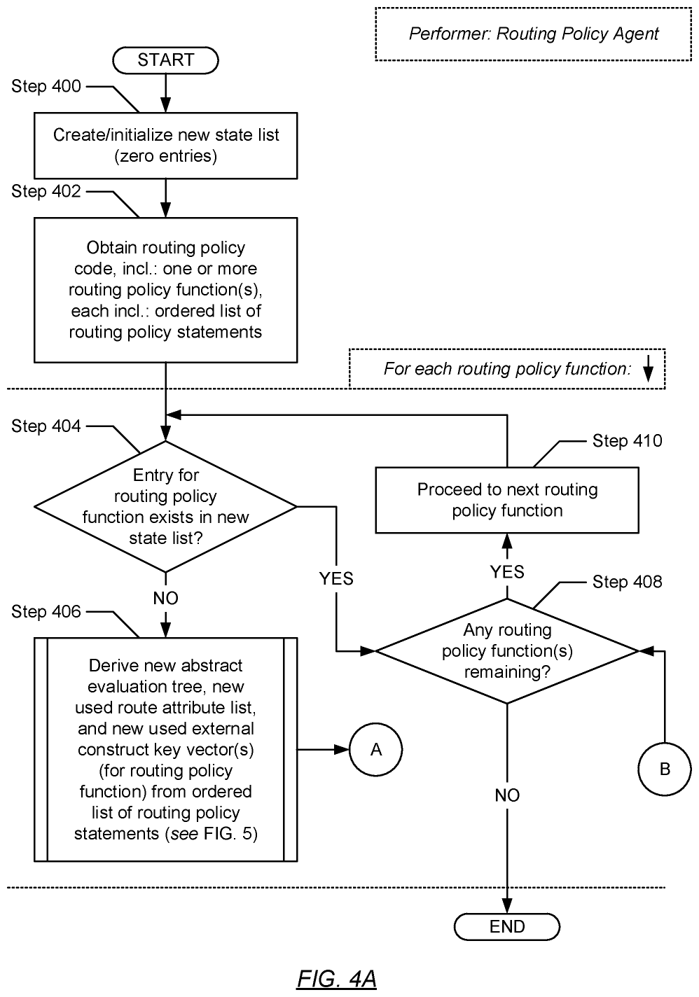

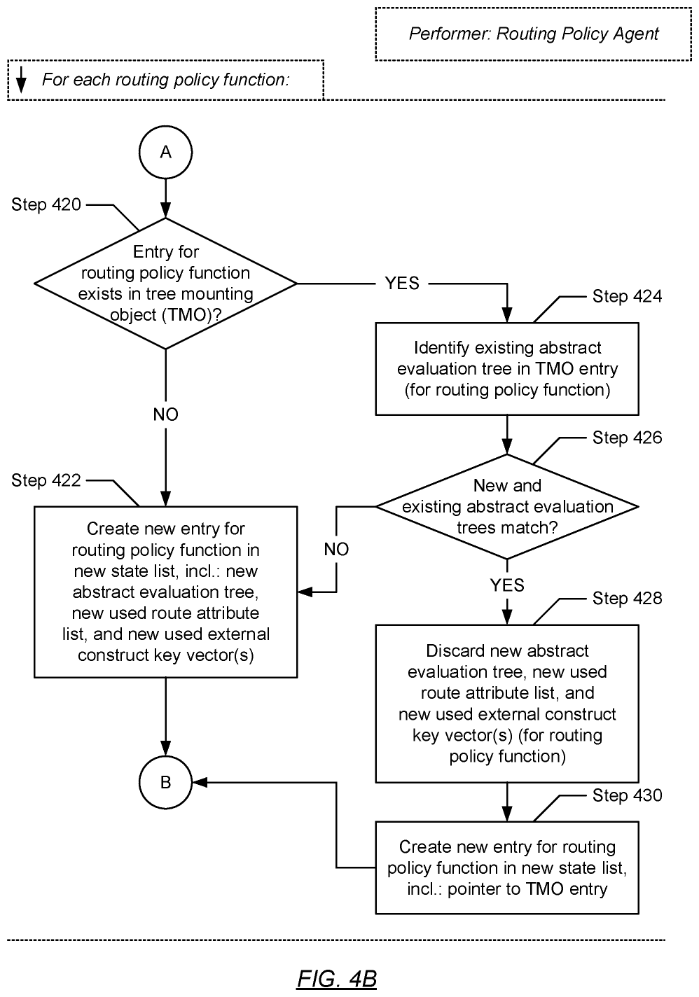

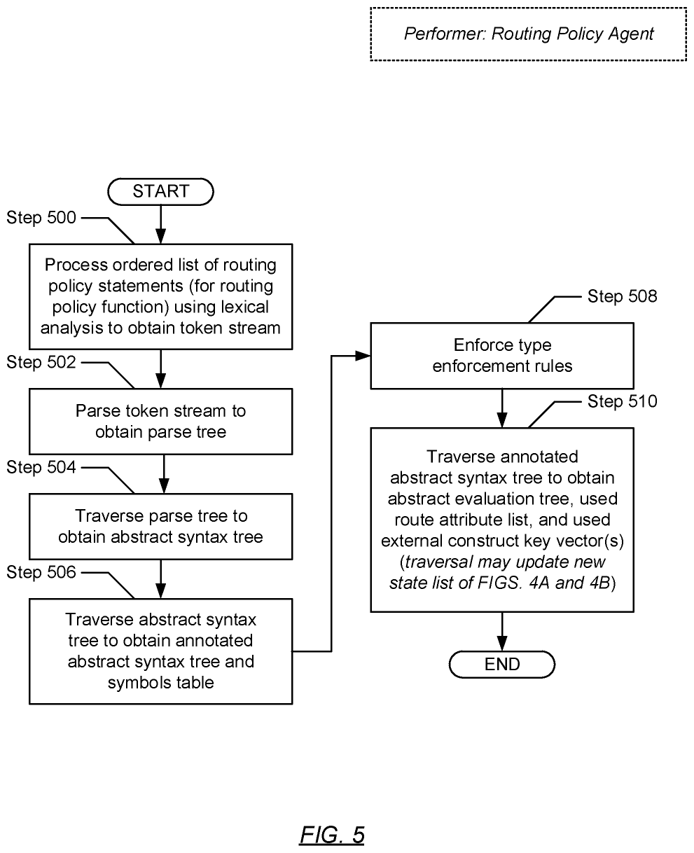

Such software and/or firmware may include instructions which, when executed by the one or more computer processors, or other hardware (e.g., circuitry) of the network device (100), cause the computer processor(s) and/or other hardware components to perform operations in accordance with one or more embodiments of the disclosure. For example, the aforementioned operations may at least include the methods outlined and described in FIGS. 4A-7B, below.

Such software and/or firmware instructions may be in the form of computer readable program code, which may, for example, be stored, in whole or in part, temporarily or permanently, on non-transitory computer readable media. Examples of the non-transitory computer readable media may include, but are not limited to, compact discs (CDs), digital versatile discs (DVDs), storage devices, diskettes, tapes, flash memory, physical memory, or any other non-transitory computer readable media.

In one embodiment of the disclosure, the network device (100) may include any number of agents (e.g., routing policy configurator (102), routing policy agent (104), and routing protocol agent(s) (106A-106N)). An agent may represent any hardware (e.g., circuitry), software, firmware, or any combination thereof that includes functionality to perform any tasks or actions for which it was designed. Examples of agent functionality may include, but are not limited to: monitoring hardware; monitoring other software; monitoring log files; receiving information; parsing information; writing information (e.g., to hardware tables); performing repetitive tasks (e.g., data backup, memory management, etc.); providing an environment for a user to interact, locally or remotely, with hardware and/or software components of the network device (100); automatically adding data to certain types of fields; performing management functions; simulating other software and/or hardware; sending an/or receiving signals (e.g., beacon signals) to determine if a device is still in contact with another device; processing/interpreting information; sending/distributing information; any other task or action; or any combination thereof.

In one embodiment of the disclosure, an agent may represent a process, or a part of a process, may include one or more threads within one or more processes, and/or may be capable of creating additional threads. Further, an agent may operatively connect to volatile storage and/or non-volatile (or persistent) storage of the network device (100). Moreover, an agent may execute within an operating system, using one or more computer processors, of the network device (100).

In one embodiment of the disclosure, at least one of the agents of the network device (100) may be the routing policy configurator (102). The routing policy configurator (102) may refer to an agent configured to facilitate routing policy generation, modification, and/or deletion. A routing policy (also referred to herein as a route selection policy) may refer to any scheme through which network routes may be modified and/or evaluated (or selected) for installation into the RIB (110) and/or into a forwarding information base (FIB) (not shown), for FEC management, for route redistribution, for route modification, for route conservation, etc. Further, the routing policy configurator (102) may be configured to facilitate the generation, modification, and/or deletion of other policies without departing from the scope of the disclosure.

In one embodiment of the disclosure, the routing policy configurator (102) may implement, or may rely on another agent (not shown) (e.g., a device interface agent) to implement, an interface through which a user (e.g., a network device or network administrator) may interact with the network device (100) and/or configure policies on the network device (100). Examples of the aforementioned interface may include, but are not limited to, a command line interface (CLI), a graphical user interface (GUI), a web interface, an application programming interface (API), or any other interface design through which users may interact with the network device (100) and/or configure policies on the network device (100).

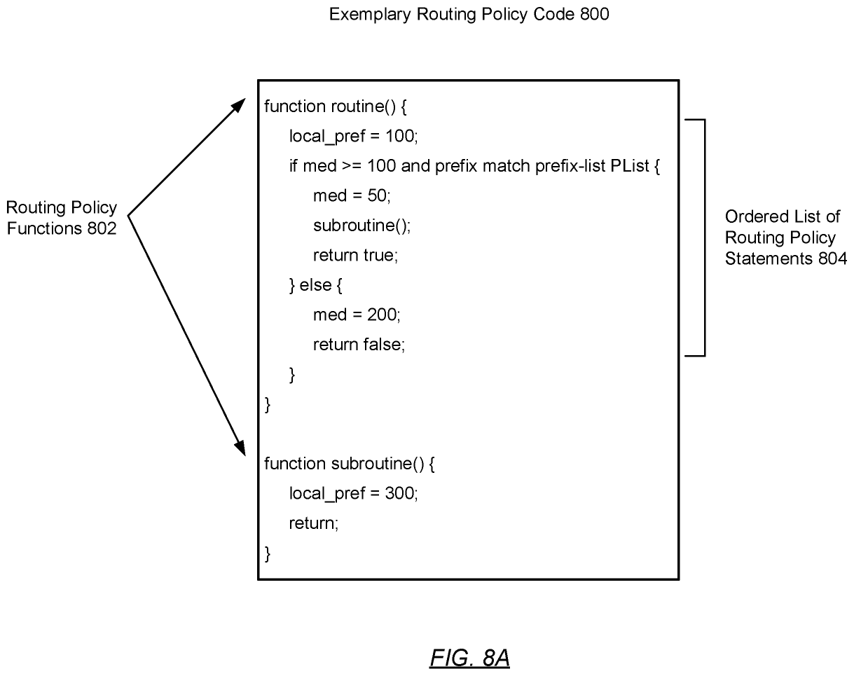

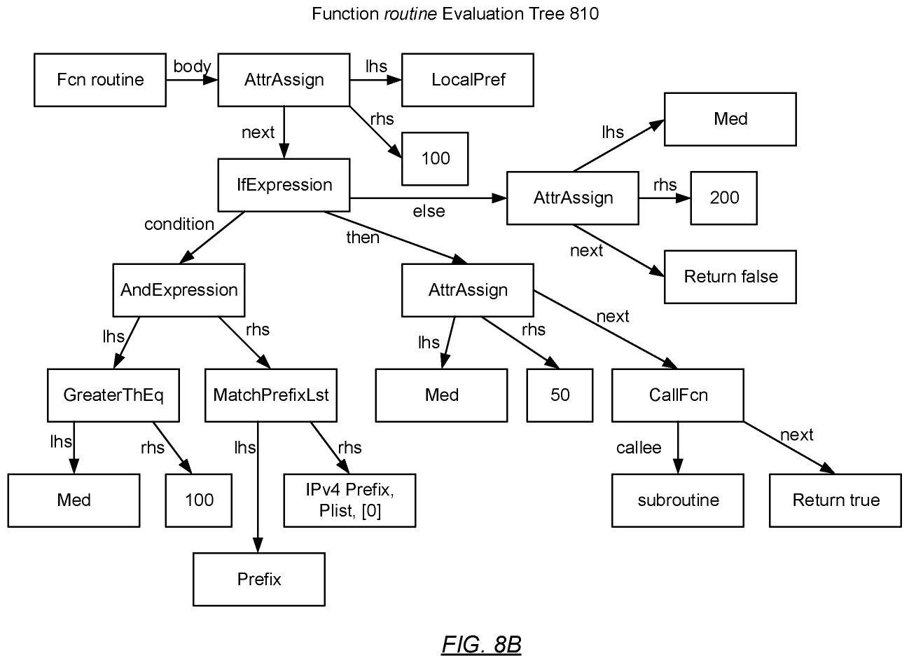

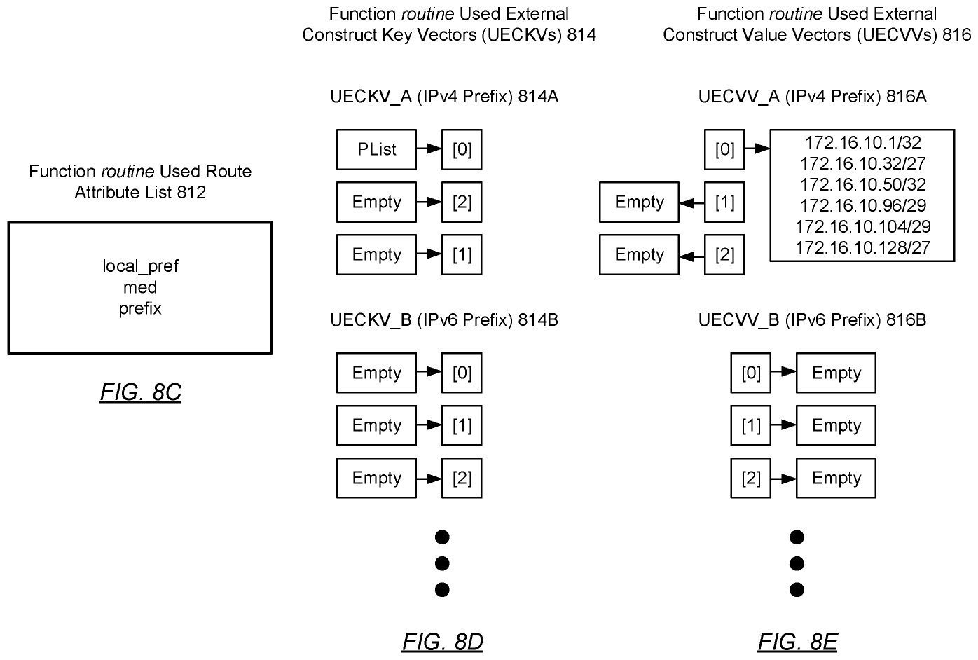

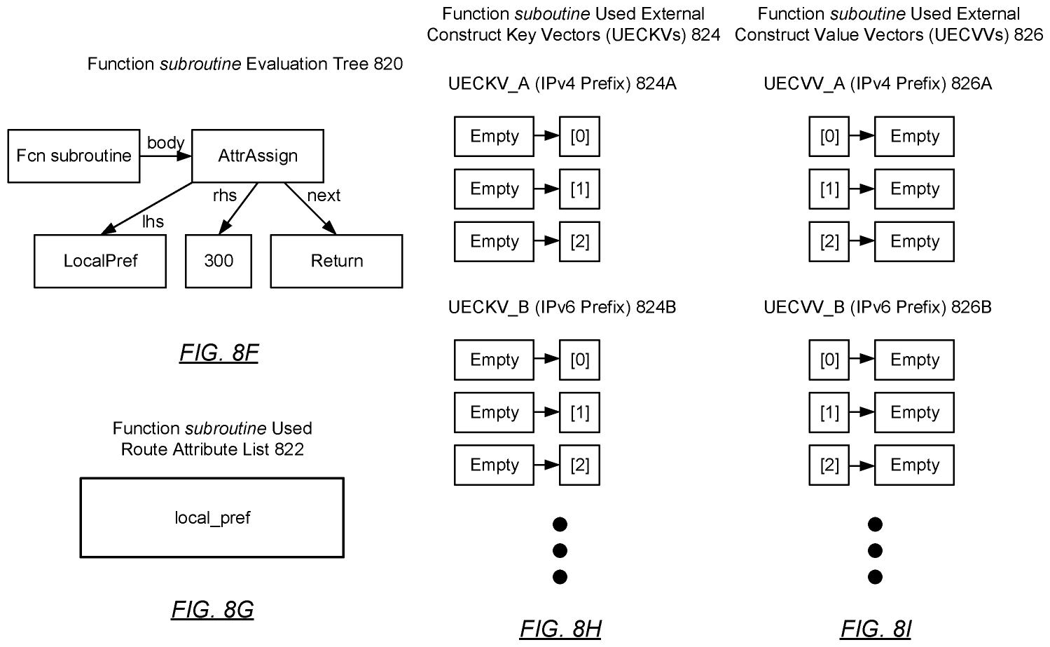

In one embodiment of the disclosure, through the implemented interface, the routing policy configurator (102) may obtain routing policy code for one or more routing policies. The routing policy code may encompass computer readable instructions for the evaluation of network routes, which may be reflected through one or more routing policy functions. A routing policy function may reference any subset (or all) of the routing policy code, which may be directed to performing any subset (or all) of the actions necessary to complete the evaluation of network routes. Should routing policy code be segmented through multiple routing policy functions, one of the routing policy functions may represent a primary routine or starting point for the evaluation of network routes, which may call upon or invoke one or more of the remaining routing policy functions. Each remaining routing policy function, henceforth, may represent a secondary routine (also referred to as a subroutine), which in itself may or may not call or invoke one or more other secondary routines. Further, each routing policy function may include an ordered list (or sequence) of routing policy statements (described below). A non-limiting example of routing policy code, including routing policy functions and routing policy statements, is illustrated and described in FIG. 8A, below.

In one embodiment of the disclosure, each statement in the ordered list of statements, of any given routing policy function, may reflect instructions to perform one or more particular functions. Examples of the particular function(s) may include, but are not limited to: a route attribute lookup entailing the retrieval of a route attribute value for a given route attribute describing a given network route; a route attribute assignment entailing the update of a route attribute value for a given route attribute describing a given network route; a calling or invocation of a subroutine, which may or may not include passing value(s) for one or more variables thereto for consideration and/or processing; an operation entailing one or more conditional expressions (e.g., if-then-else expressions, while expressions, case expressions, switch expressions, etc.); an operation entailing one or more external constructs (described below); and a route action targeting a network route (e.g., the installation permission or denial of the network route into the RIB (110)). The particular function(s), specified in a/each statement of any routing policy function, is/are not limited to the aforementioned examples.

In one embodiment of the disclosure, at least one of the agents of the network device (100) may be the routing policy agent (104). The routing policy agent (104) may refer to an agent configured for routing policy code (describe above) compilation. Through said compilation, the routing policy agent (104) may include functionality to translate routing policy code into one or more abstract evaluation trees (also referred to as policy trees or evaluation trees)—one for each routing policy function of the routing policy code. An evaluation tree may refer to a hierarchical structure that serves as an efficient representation of routing policies for runtime evaluation. Non-limiting examples of an evaluation tree are illustrated and described in FIGS. 8B and 8F, below.

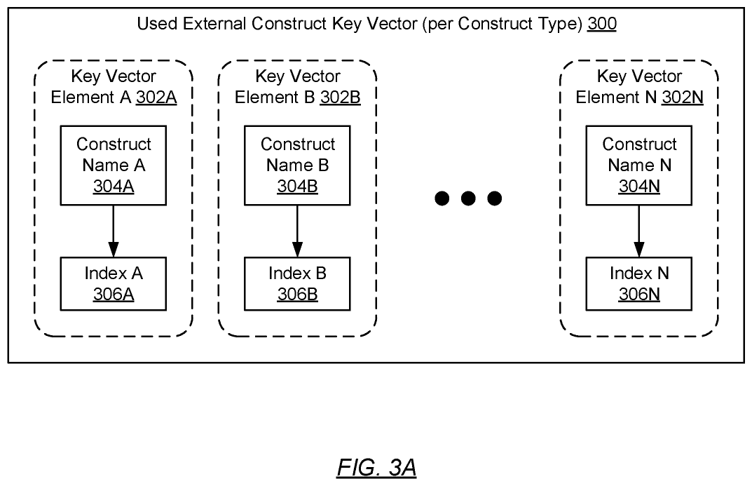

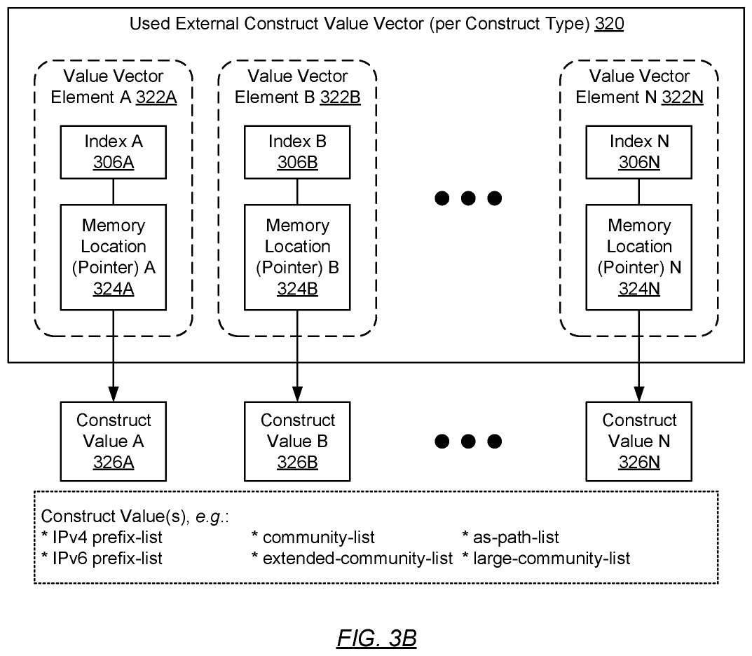

Further, in one embodiment of the disclosure, from the routing policy code, the routing policy agent (104) may also include functionality to produce a used route attribute list (see e.g., FIGS. 8C and 8G) and any number of used external construct key vectors (see e.g., FIGS. 3A, 8D, and 8H) for each routing policy function of the routing policy code. Briefly, the used route attribute list may encompass a data structure (e.g., table) that lists, or otherwise includes entries specifying, one or more unique route attributes, which may be used within a given routing policy function. Meanwhile, a used external construct key vector may encompass a data structure (e.g., array) per construct type (e.g., a prefix list, a community list, an autonomous system (AS)-path access list, etc.) that includes any number of indexed elements—each of which may associate with an external construct name used within the given routing policy function.

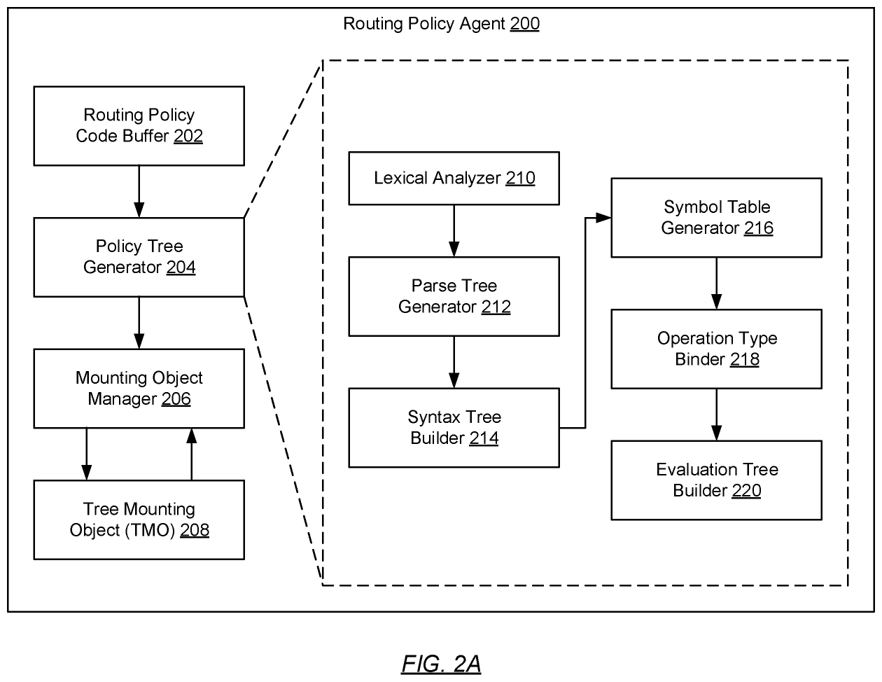

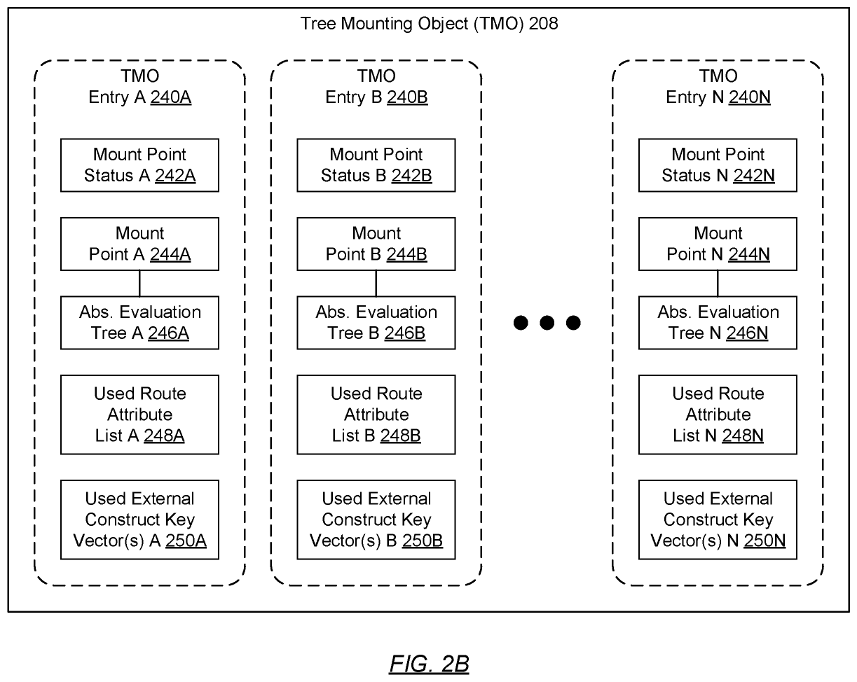

Details pertaining to the compilation of routing policy code, by the routing policy agent (104), is described through the method outlined in FIG. 5, below. The routing policy agent (104) may include further functionality to perform the method outlined in FIGS. 4A and 4B, as well as FIG. 6, below, which may be directed to new state list generation and tree mounting object updating, respectively. One of ordinary skill will appreciate that the routing policy agent (104) may perform other functionalities without departing from the scope of the disclosure. The routing policy agent (104) is described in further detail in FIG. 2A, below.

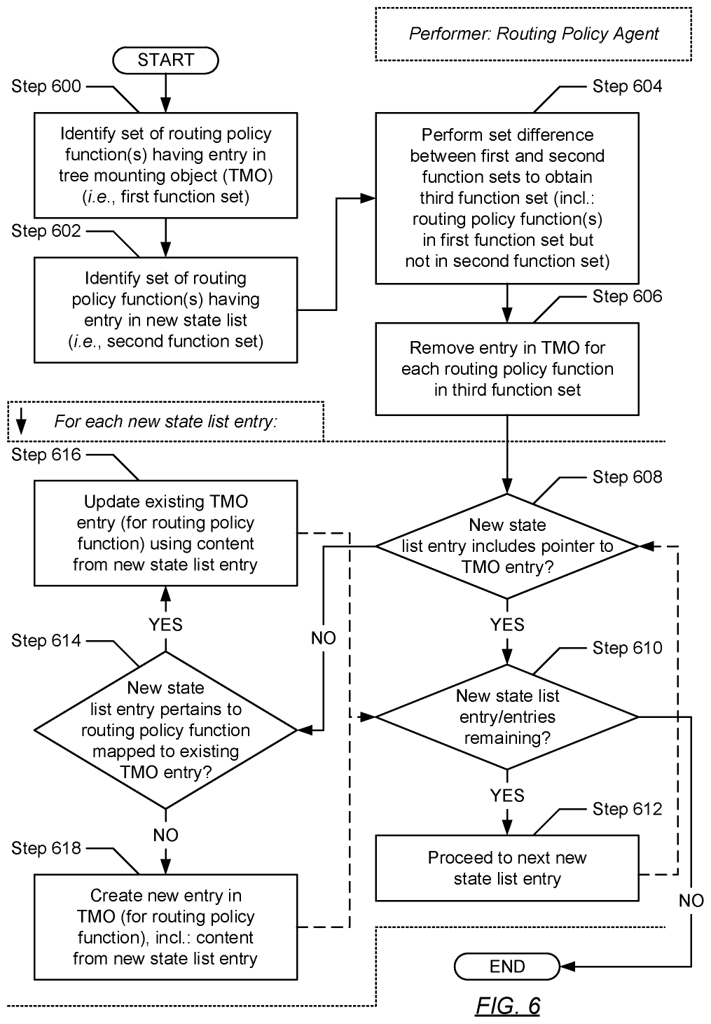

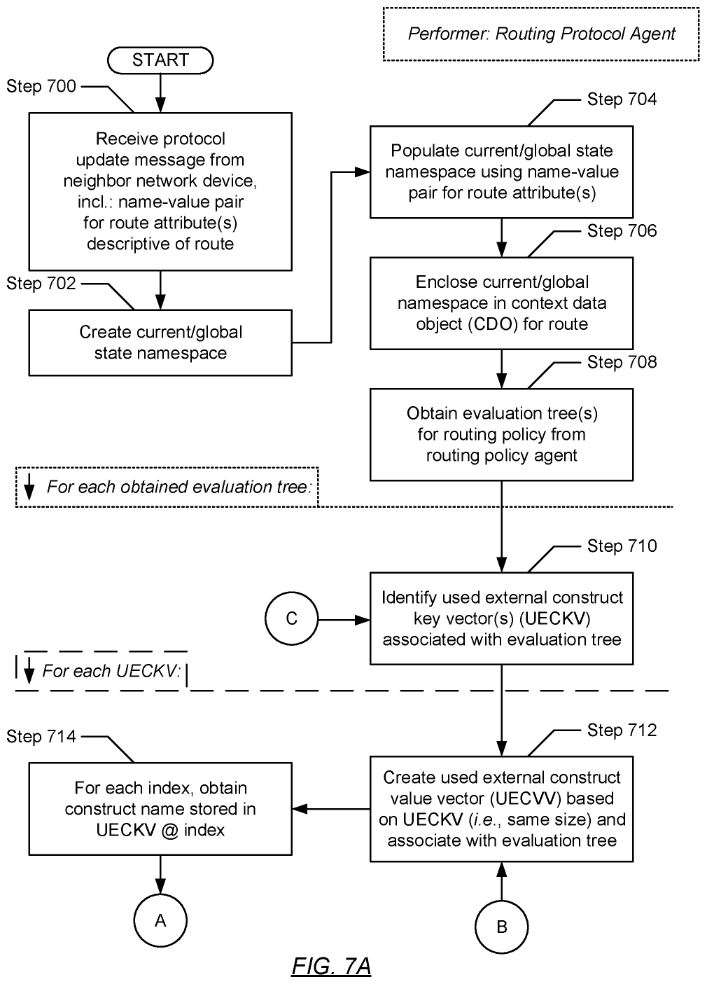

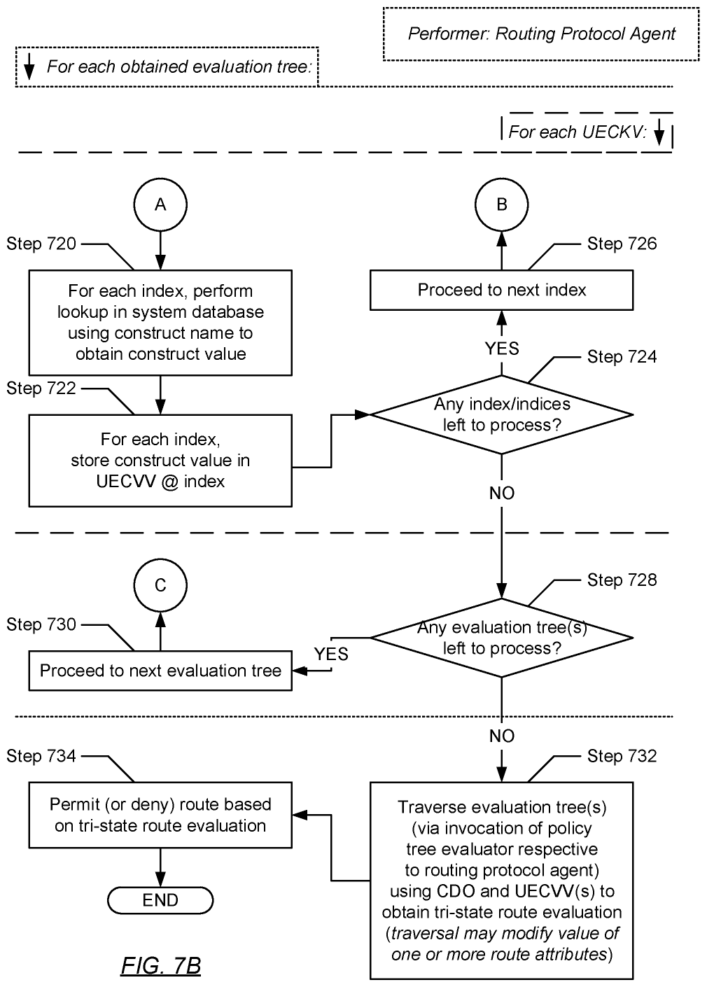

In one embodiment of the disclosure, one or more of the agents of the network device (100) may be the routing protocol agent(s) (106A-106N). A routing protocol agent (106A-106N) may refer to an agent configured to implement a routing protocol. A routing protocol, in turn, may refer to a networking protocol directed to managing route information in a network. For example, a routing protocol may learn route information from neighbor network devices, store such route information, share route information with other neighbor network devices, and process the route information in accordance with embodiments of the disclosure. Furthermore, any routing protocol agent (106A-106N) may include functionality to at least perform the method outlined in FIGS. 7A and 7B, below, which is directed to route evaluation.

Examples of the routing protocol agent(s) (106A-106N) may include, but are not limited to: a Border Gateway Protocol (BGP) agent; an Interior Gateway Protocol (IGP) agent (e.g., Open Shortest Path First (OSPF), Routing Information Protocol (RIP), Intermediate System to Intermediate System (IS-IS), Enhanced Interior Gateway Routing Protocol (EIGRP), etc.); and a static route agent.

In one embodiment of the disclosure, each routing protocol agent (106A-106N) may include a policy tree evaluator (108A-108N). A policy tree evaluator (108A-108N) may refer to a process or thread that enables a routing protocol agent (106A-106N) to evaluate network routes using route information thereof and evaluation tree(s) representative of routing policies. The aforementioned route information, for any given network route, may take shape as a context data object (CDO) (see e.g., FIG. 3C) reflective of the given network route. Briefly, a CDO may represent a data container wherein a current (or global) state namespace, pertinent to a given network route, may be stored. The current/global state namespace, in turn, may maintain a current or present state of a set of route attributes reflective of the given network route.

In one embodiment of the disclosure, the routing protocol agent(s) (106A-106N) may operatively connect to the RIB (110). The RIB (110) may represent a data structure, which may be implemented in the memory and/or the persistent storage of the network device (100). Specifically, the RIB (110) may represent a data structure that stores information related to network routes, which may be statically configured, learned dynamically from a routing protocol agent (106A-106N), or relate to networks directly connected to the network device (100). Information relating to a given network route may be stored as a RIB entry in the RIB (110). The aforementioned information, pertinent to a given network route and stored in a given RIB entry, may include, but is not limited to, a destination subnet identifying a network, a next-hop to reach the network, an interface of the network device (100) connected to the next-hop, various metrics describing the given network route, and/or any other information relevant to the given network route. Furthermore, the routing protocol agent(s) (106A-106N) may, at least in part, manage the RIB (110), which may include, for example, adding RIB entries, removing RIB entries, and/or modifying RIB entries.

While FIG. 1 shows a configuration of components, other network device (100) configurations may be used without departing from the scope of the disclosure.

FIG. 2A shows a routing policy agent in accordance with one or more embodiments of the disclosure. The routing policy agent (200) may include a routing policy code buffer (202), a policy (or evaluation) tree generator (204), a mounting object manager (206), and a tree mounting object (TMO) (208). Each of these routing policy agent (200) subcomponents is described below.

In one embodiment of the disclosure, the routing policy buffer (202) may refer to computer memory (e.g., at least a portion of the memory available on a network device) wherein routing policy code (described above), sought to be compiled, may be temporarily maintained. The aforementioned routing policy code is not limited to a single routing policy, nor a single instance of the same routing policy. That is, the routing policy buffer (202) may include functionality to temporarily maintain routing policy codes for multiple routing policies and/or concurrent edits of a same routing policy, which may be sought for compilation at any given time, and by one or many users.

In one embodiment of the disclosure, the policy tree generator (204) may refer to a computer program, process, or thread configured to verify any routing policy code, sought to be compiled, maintained in the routing policy buffer (202) and transform each routing policy code into one or more abstract evaluation trees, a used route attribute list, and a used external construct vector (described above). The process through which routing policy code may be verified and transformed may include operations performed by a sequence of code processing pipeline elements of the policy tree generator (204). The aforementioned code processing pipeline elements may include, but are not limited to, a lexical analyzer (210), a parse tree generator (212), a syntax tree builder (214), a symbol table generator (216), an operation type binder (218), and an evaluation tree builder (220). Each of these policy tree generator (204) subcomponents is described below.

In one embodiment of the disclosure, the lexical analyzer (210) may refer to a computer program, process, or thread configured to perform lexical analysis. Through lexical analysis, routing policy code (obtained from the routing policy buffer (202)) may first be converted into a stream or sequence of characters, which may then be tokenized to obtain a stream or sequence of tokens. A token may refer to a group of consecutive characters (i.e., a character string) that hold an assigned meaning to the lexical analyzer (210). Which assigned meaning may be contingent on the character pattern of the token, which may match any one of many predefined token categories. By way of examples, a token category may include, but is not limited to, identifiers (e.g., code terms created by a user), keywords (e.g., code terms reserved and used by a programming language), separators (e.g., characters or punctuation that may be used by the programming language as delimiters), and operators (e.g., symbols that operate on arguments to produce results). A token category is not limited to the aforementioned examples.

In one embodiment of the disclosure, the parse tree generator (212) may refer to a computer program, process, or thread configured to perform syntax analysis. Through syntax analysis, the stream or sequence of tokens (obtained from the lexical analyzer (210)) may be examined to determine whether the stream or sequence of tokens reflect a correct syntax for a language (e.g., a programming language) in which the routing policy code had been written. To make the determination, the parse tree generator (212) may include functionality to attempt the construction of a parse tree using a predefined grammar (e.g., a set of production rules) of the aforementioned language and the stream or sequence of tokens. A parse tree may refer to a graphical representation of a derivation (e.g., a sequence of the production rules) of the stream or sequence of tokens through the application of the predefined grammar.

Substantively, in one embodiment of the disclosure, if a parse tree is successfully generated for the stream or sequence of tokens, from the predefined grammar, then the stream or sequence of tokens reflect a correct syntax for the language. On the other hand, in another embodiment of the disclosure, if the stream or sequence of tokens cannot be derived using the predefined grammar, thereby not leading to the successful construction of an associated parse tree, then the stream or sequence of tokens alternatively do not reflect the correct syntax for the language. Further, in the former circumstance, upon determining that the stream or sequence of tokens is/are syntactically correct, the successfully generated parse tree may be provided to the syntax tree builder (214) for further processing.

In one embodiment of the disclosure, the syntax tree builder (214) may refer to a computer program, process, or thread configured to build abstract syntax trees (also referred to as syntax trees). A syntax tree, in turn, may refer to a redacted parse tree that omits the syntactic elements thereof, thereby producing a hierarchical structure that focuses on the semantics (i.e., meaning) of the routing policy code. Examples of syntactic elements, which may be removed from a parse tree to obtain a syntax tree, may include, but are not limited to, tokens classified as separators (e.g., punctuation or delimiter characters/symbols such as braces, semicolons, parentheses, etc.) and user comments embedded throughout the routing policy code. Transformation of a parse tree into a syntax tree is not limited to the aforementioned techniques. Moreover, upon building a syntax tree, the syntax tree builder (214) may include functionality to provide the syntax tree to the symbol table generator (216) for further processing.

In one embodiment of the disclosure, the symbol table generator (216) may refer to a computer program, process, or thread configured to generate symbol tables. A symbol table may refer to a data structure that maintains entries associating symbols, of the routing policy code, with information relating to the declaration or appearance of the symbols in the abstract syntax tree (obtained from the syntax tree builder (214)). A symbol, in turn, may refer to an identifier—i.e., any token classified as an identifier (e.g., code terms created by a user), which may include, but are not limited to, tokens that may denote variables, external constructs (e.g., prefix lists, community lists, autonomous system (AS)-path access lists, etc.), types, labels, subroutines, and packages. The aforementioned information, which may relate to the declaration or appearance of a given symbol, may include a pointer or reference to a corresponding node in the abstract syntax tree where the given symbol may be defined or, alternatively, may include a pointer or reference to information predefined elsewhere (e.g., a system database).

In one embodiment of the disclosure, apart from generating symbol tables, the symbol table generator (216) may also include functionality to annotate abstract syntax trees to obtain annotated abstracted syntax trees (also referred to as annotated syntax trees). An annotated syntax tree may refer to an abstract syntax tree that reflects supplemental information concerning any subset or all of the nodes forming the abstract syntax tree. The aforementioned supplemental information may include, but is not limited to, associations to one or more symbols specified in the symbol table(s). The symbol table generator (216), thereafter, may pass the generated symbol tables and annotated syntax trees to the operation type binder (218).

In one embodiment of the disclosure, the operation type binder (218) may refer to a computer program, process, or thread configured to enforce type enforcement rules. Within any given language (e.g., a programming language in which the routing policy code had been written), there are often various types of data (e.g., integers, characters, Booleans, strings, decimals, prefixes, addresses, communities, etc.), which may be defined and handled thereby. Constants, variables, and/or subroutines declared in any computer readable program code (e.g., the routing policy code), written using the given language, must subsequently be described with one of these defined data types. Further, certain operations, performed by way of the program code, may only succeed while being applied to certain data types. These certain operations must also yield results (if applicable) using certain data types in order to guarantee a certain consistency of results throughout.

In one embodiment of the disclosure, a type enforcement rule, subsequently, refers to a governing principle that enforces the above-mentioned data typing on the argument(s) and result for a given operation. The given operation may include, but is not limited to, one of the following operations: (a) a relational operation, which may entail a relational operator (e.g., equal to (=), not equal to (≠), greater than (>), less than (<), greater than or equal to (≥), less than or equal to (≤) used between comparable data types and may yield a Boolean data type result—example rule: (integer data type)>(integer data type)→Boolean (e.g., true or false); (b) a logical operation, which may entail a logical operator (e.g., AND, OR, NOT) used between comparable data types and may yield a Boolean or tri-state (e.g., true, false, or unknown) data type result—example rule: (Boolean data type) OR (Boolean data type)→Boolean; (c) a match or match-exact operation, which may entail determining whether an item of a given data type is included amongst a list of items (or an external construct) of the given data type and may yield a Boolean data type result—example rule: (prefix data type) match (prefix-list)→Boolean; and (d) a variable (e.g., route attribute) assignment operation, which may entail assigning a value of a given data type to a variable declared using the given data type—example rule: (variable of integer data type)=(constant of integer data type). The given operation is not limited to the aforementioned examples.

Furthermore, in one embodiment of the disclosure, upon enforcing any type enforcement rules, the operation type binder (218) may relay the annotated syntax tree(s) (obtained from the symbol table generator (216)) to the evaluation tree builder (220).

In one embodiment of the disclosure, the evaluation tree builder (220) may refer to a computer program, process, or thread configured to build abstract evaluation trees, as well as to produce used route attribute lists and used external construct key vectors. As briefly defined above, an abstract evaluation tree (also referred to as a policy tree or an evaluation tree) may refer to a hierarchical structure that serves as an efficient representation of a given routing policy function for runtime evaluation. To that extent, any abstract evaluation tree may be efficient (or fast) with respect to facilitating the evaluation of network routes at runtime. This may be the case because certain procedures (described above), exhibited in existing network route evaluation techniques, which are known to bottleneck or congest the network route evaluation process at their runtime, are instead performed at a creation time of an abstract evaluation tree rather than the runtime of the network route evaluation. Furthermore, a used route attribute list may encompass a data structure (e.g., table) that lists, or otherwise includes entries specifying, one or more unique route attributes, which may be used within the given routing policy function. Meanwhile, a used external construct key vector may encompass a data structure (e.g., array) per construct type (e.g., a prefix list, a community list, an autonomous system (AS)-path access list, etc.) that includes any number of indexed elements—each of which may associate with an external construct name used within the given routing policy function.

In one embodiment of the disclosure, the evaluation tree builder (220) may build one or more evaluation trees, one or more used route attribute lists, and one or more sets of used external construct key vectors—associated with one or more routing policy functions, respectively, for a given routing policy—at least from the annotated syntax tree(s) (obtained from the operation type binder (218)). Specifically, an evaluation tree may substantially mirror the structure of an annotated syntax tree. Further, while traversing an annotated syntax tree, unique route attribute(s) specified throughout the annotated syntax tree may be tracked within a used route attribute list. Moreover, while traversing an annotated syntax tree, name(s) pertaining to unique external construct(s) may each be assigned an index (i.e., a whole number) and tracked within a used external construct key vector organized per construct type (e.g., prefix list, community list, autonomous system (AS)-path access list, etc.).

In one embodiment of the disclosure, the mounting object manager (206) may refer to computer program, process, or thread configured to manage the TMO (208) (described below). To that extent, the mounting object manager (206) may include functionality to create, delete, or edit/update entries (described below) (see e.g., FIG. 2B) contained in the TMO (208). In creating and/or editing/updating a TMO entry, the mounting object manager (206) may include further functionality to perform a substantive portion of the method illustrated and described in FIG. 6 below, which is directed to the updating of the TMO (208).

In one embodiment of the disclosure, the TMO (208) may refer to a data container (implemented through computer memory and/or persistent storage) in which outputs of the policy tree generator (204) may be mounted, maintained, and made available to the routing protocol agent(s) (see e.g., FIG. 1) on the network device. The aforementioned outputs, as a reminder, may include abstract evaluation tree(s), a used route attribute list, and any number of used external construct key vectors for each of any number of routing policy functions (within routing policy code of any number of routing policies) that had undergone the compilation process. The TMO (208) is described in further detail in FIG. 2B, below.

While FIG. 2A shows a configuration of subcomponents, other routing policy agent (200) configurations may be used without departing from the scope of the disclosure.

FIG. 2B shows a tree mounting object (TMO) in accordance with one or more embodiments of the disclosure. The TMO (208) may refer to a data container in which data structures, pertinent to the efficient runtime evaluation of routing policies, may be mounted, maintained, and made available to any number of routing protocol agents on a network device (see e.g., FIG. 1).

Particularly, in one embodiment of the disclosure, the TMO (208) may include any number of TMO entries (240A-240N)—each of which may pertain to or may be associated with one routing policy function (of any number of routing policy functions declared in one or more routing policies). Any given TMO entry (240A-204N) may refer to a data container or a directory in a file system in which information, including data structures, representative of a given routing policy function may be maintained. The aforementioned information may include a mount point status (242A-242N), a mount point (244A-244N), an evaluation tree (246A-246N), a used route attribute list (247A-248N), and one or more used external construct key vectors (250A-250N). Each of these TMO entry (240A-240N) subcomponents is described below.

In one embodiment of the disclosure, the mount point status (242A-242N) may refer to an indicator (e.g., a variable) configured to reflect a state of the mount point (244A-244N) at a given point-in-time. The state of the mount point (244A-244N), in turn, may be governed by an availability of the evaluation tree (246A-246N), which may or may not be mounted at the mount point (244A-244N) at the given point-in-time. Specifically, when the evaluation tree (246A-246N) is mounted, the mount point status (242A-242N) may reflect a first binary state (e.g., true, 1, or on) indicating that the mount point (244A-244N) is occupied and, accordingly, indicating that the evaluation tree (246A-246N) is accessible. Conversely, when the evaluation tree (246A-246N) is unmounted, the mount point status (242A-242N) may reflect a second binary state (e.g., false, 0, or off) indicating that the mount point (244A-244N) is unoccupied and, accordingly, indicating that the evaluation tree (246A-246N) is inaccessible. Further, the mount point status (242A-242N) may be made accessible to the routing protocol agent(s) of the network device (see e.g., FIG. 1). That is, any given routing protocol agent may include functionality to read the mount point status (242A-242N) when seeking to gain access to the evaluation tree (246A-246N) for network route evaluation purposes.

In one embodiment of the disclosure, the mount point (244A-244N) may refer to an access point or memory location where the evaluation tree (246A-246N) may be made available or accessible to the routing protocol agent(s) of the network device for use. As mentioned above, the mount point (244A-244N) may either be occupied or unoccupied by the evaluation tree (246A-246N) at any given point-in-time. Particularly, when the evaluation tree (246A-246N) is mounted thereto, the mount point (244A-244N) may map to or reference a root node of the evaluation tree (246A-246N) (see e.g., the node labeled “Fcn routine” of the exemplary evaluation tree illustrated in FIG. 8B).

In one embodiment of the disclosure, the evaluation tree (246A-246N) may refer to a hierarchical structure that serves as an efficient representation of a given routing policy function for runtime evaluation. The evaluation tree (246A-246N) may resemble a directed graph that sequences operations to be performed on or using a context data object (CDO) (described below) (see e.g., FIG. 3), which may encompass a collection of nodes or vertices connected by a collection edges, where the edges each have a direction associated with them (see e.g., FIGS. 8B and 8F). Of the collection of nodes, one is representative of a root node, whereas the others are each either representative of a branch node or a leaf node. A root node may be minimally defined as having no (i.e., zero) parent nodes; a branch node may be minimally defined as having at least one parent node and at least one child node; and a leaf node may be minimally defined as having no (i.e., zero) child nodes.

In one embodiment of the disclosure, the root node of the evaluation tree (246A-246N) may include or reflect a function name of the routing policy function of which the evaluation tree (246A-246N) is an efficient representation. On the other hand, each branch node of the evaluation tree (246A-246N) may include or reflect a construct recited in the code of the routing policy function. By way of examples, the construct may include, but is not limited to, a conditional expression (e.g., if-condition-then-else expression), a route attribute assignment expression, a route attribute lookup expression, a subroutine call or invocation, a relational operation or operand, a logical operation or operand, a match or match-exact expression. The construct is not limited to the aforementioned examples. Meanwhile, each leaf node of the evaluation tree (246A-246N) may include or reflect a parameter pertinent to the evaluation of a construct. By way of examples, the parameter may include, but is not limited to, a variable (e.g., route attribute) name, a variable value, a constant value, a return state, an index to a given vector element of the used external construct vector (250A-250N) (described below), and a subroutine or callee function name.

Moreover, in one embodiment of the disclosure, each edge connecting a pair of nodes (e.g., the root node to a branch node, a branch node to another branch node, or a branch node to a leaf node) may reflect a label or annotation specifying a relationship of the latter node (i.e., child node) to the former node (i.e., parent node). The relationship may, more specifically, indicate the relation of: a construct to the function name of the routing policy function; a construct to another construct; or a parameter to a construct. To that extent, by way of examples, the relationship may denote that: a parameter (e.g., a variable name) is a left-hand-side (lhs) argument of a construct (e.g., a route attribute assignment expression); a parameter (e.g., a constant value) is a right-hand-side (rhs) argument of a construct (e.g., a route attribute assignment expression); a first construct (e.g., an AND logical operation/operand) is a condition of a second construct (e.g., an if-condition-else-then expression); and a construct (e.g., a route attribute lookup expression) is a starting point for a body of the routing policy function that stems from the function name. The relationship between any given pair of nodes is not limited to the aforementioned examples.

In one embodiment of the disclosure, the used route attribute list (248A-248N) may refer to a data structure (e.g., table) that lists, or otherwise includes entries specifying, one or more unique route attributes, which may be used or recited within the routing policy function pertaining to the mount point element (240A-240N). The route attribute(s) may conform to network route pertinent information described, or otherwise offered, by a given routing protocol—e.g., the routing protocol through which the network device (see e.g., FIG. 1) received the given network route. For example, with respect to the Border Gateway Protocol (BGP), examples of the route attribute(s) (also referred to as BGP metrics or BGP path attributes) may include, but are not limited to, an ORIGIN attribute, an AS PATH attribute, a NEXT_HOP attribute, a MULTI_EXIT_DISC (or MED) attribute, a LOCAL_PREF attribute, an ATOMIC_AGGREGATE attribute, an AGGREGATOR attribute, a COMMUNITY attribute, etc. The aforementioned route attribute examples are well-known in the art and will not be described in further detail in the disclosure. Further, for examples of the used route attribute list (248A-248N), refer to FIGS. 8C and 8G, below.

In one embodiment of the disclosure, a used external construct key vector (250A-250N) may refer to a data structure (e.g., array) per construct type (e.g., a prefix list, a community list, an autonomous system (AS)-path access list, etc.) that includes any number of indexed elements—each of which may associate with an external construct name used within the routing policy function pertaining to the TMO entry (240A-240N). An external construct, in turn, may refer to a data object (e.g., a variable, a file, a data structure) employed in the configuration of network protocol route filtering. Examples of an external construct may include, but are not limited to, a prefix list, a community list, an autonomous system (AS)-path access list, an extended-community list, and a large-community list. The used external construct key vector (250A-250N) is described in further detail in FIG. 3A, below.

While FIG. 2B shows a configuration of subcomponents, other tree mounting object (208) configurations may be used without departing from the scope of the disclosure. For example, in one embodiment of the disclosure, each TMO entry (240A-240N) may further include or may be associated with an index (not shown) or key, which may serve to uniquely identify the TMO entry (240A-240N).

FIG. 3A shows a used external construct key vector in accordance with one or more embodiments of the disclosure. The used external construct key vector (300) may encompass a data structure (e.g., array) that includes one or more data entries (referred to hereinafter as key vector elements (302A-302N)). Each key vector element (302A-302N) may pertain to or may be associated with a unique external construct (described above) (see e.g., FIG. 2B) of a given construct type (e.g., prefix list, community list, autonomous system (AS)-path access list, etc.) used or recited within a given routing policy function. Each key vector element (302A-302N) may subsequently include a construct name (304A-304N) of a given unique external construct and an index (306A-306N) assigned thereto. Each of these key vector element (302A-302N) subcomponents is described below.

In one embodiment of the disclosure, the construct name (304A-304N) may represent any arbitrary-length character string (e.g., including letters, numbers, symbols, or any combination thereof) by which the given unique external construct may be referred or labeled. On the other hand, the index (306A-306N) may refer to a non-negative scalar integer (or whole number) that addresses or identifies the given key vector element (302A-302N) in a given used external construct key vector (300) that includes the aforementioned construct name (304A-304N).

In one embodiment of the disclosure, generation of any used external construct key vector (300) may transpire during compilation of the routing policy code (see e.g., element 204 in FIG. 2A described above) for a given routing policy.

While FIG. 3A shows a configuration of subcomponents, other used external construct key vector (300) configurations may be used without departing from the scope of the disclosure.

FIG. 3B shows a used external construct value vector in accordance with one or more embodiments of the disclosure. The used external construct value vector (320) may encompass a data structure (e.g., array) that includes one or more data entries (referred to hereinafter as value vector elements (322A-322N)). Each value vector element (322A-322N) may pertain to or may be associated with a unique external construct (described above) (see e.g., FIG. 2B) of a given construct type (e.g., prefix list, community list, autonomous system (AS)-path access list, etc.) used or recited within a given routing policy function. Each value vector element (322A-322N) may subsequently include an index (306A-306N) assigned thereto and a pointer (324A-324N). Each of these value vector element (322A-322N) subcomponents is described below.

In one embodiment of the disclosure, the index (306A-306N) may refer to a non-negative scalar integer or whole number that addresses or identifies the given value vector element (322A-322N) in a given used external construct value vector (320) that includes a given pointer (324A-324N). Further, the index (306A-306N) here may be the same index (306A-306N) associated with a given key vector element in a given used external construct key vector (described above) (see e.g., FIG. 3A). The given key vector element may include a given construct name of a given unique external construct, which may map to the given pointer (324A-324N).

On the other hand, in one embodiment of the disclosure, the given pointer (324A-324N) may refer to a memory location (i.e., a location in computer memory) where a construct value (326A-326N) of the aforementioned given unique external construct may be stored. The construct value (326A-326N), in turn, may depend on the construct type (e.g., prefix list, community list, autonomous system (AS)-path access list, etc.) with which the given used external construct key vector and the given used external construct value vector (320) may be associated. Accordingly, by way of an example, should the construct type reference prefix lists, the construct value (326A-326N) may reveal a set of network prefixes (or alternatively, a wildcard value) that may be used in comparison or match operations against a network prefix for a given network route undergoing evaluation.

In one embodiment of the disclosure, generation of any used external construct value vector (320) may transpire at any point-in-time independent of the compilation of the routing policy code (see e.g., element 204 in FIG. 2A described above) for a given routing policy. That is, any used external construct value vector (320) may be generated prior to, during, and/or even following the compilation of the routing policy code.

While FIG. 3B shows a configuration of subcomponents, other used external construct value vector (320) configurations may be used without departing from the scope of the disclosure.

FIG. 3C shows a context data object in accordance with one or more embodiments of the disclosure. A context data object (CDO) (340) may represent a data container, which may pertain to a given network route, and may be created to hold a current (or global) state namespace (342). Generally, a state namespace may reference an abstract container that stores a given snapshot (or state) of one or more route attributes (344A-344N) recorded at a given point-in-time and descriptive of the given network route. The current/global namespace (342), specifically, may represent a state namespace that maintains a current route attribute value for each of the one or more route attributes specified therein. A current route attribute value may reflect a present or latest snapshot (or state) of a route attribute (344A-344N) that exists at a present point-in-time.

Further, in one embodiment of the disclosure, each route attribute (344A-344N) specified in the current/global state namespace (342) may be maintained in the form of a route attribute name-value pair. A route attribute name-value pair may represent an associated data representation that includes two related data elements—i.e., a route attribute name and a route attribute value. The route attribute name may refer to any arbitrary-length character string (e.g., including letters, numbers, symbols, or any combination thereof) that serves to uniquely identify a given route attribute (324A-324N). The route attribute value, on the other hand, may refer to any quantitative (e.g., numerical, interval, ratio, etc.) or qualitative (e.g., categorical, nominal, ordinal, etc.) state or measurement reflective of the given route attribute (344A-344N).

While FIG. 3C shows a configuration of subcomponents, other context data object (340) configurations may be used without departing from the scope of the disclosure.

FIGS. 4A and 4B shows flowcharts describing a method for generating a new state list in accordance with one or more embodiments of the disclosure. The various steps outlined below may be performed by the routing policy agent (see e.g., FIG. 1). Further, while the various steps in the flowcharts are presented and described sequentially, one of ordinary skill will appreciate that some or all steps may be executed in different orders, may be combined or omitted, and some or all steps may be executed in parallel.

Turning to FIG. 4A, in Step 400, a new state list is created and/or initialized. In one embodiment of the disclosure, the new state list may refer to a data object (e.g., a file or a data structure) within which a most current state (in terms of abstract evaluation tree(s), used route attribute list(s), and set(s) of used external construct key vectors) of a routing policy may be temporarily or transitively stored. Further, the new state list may be created and/or initialized to include zero entries.

In Step 402, a routing policy code, for and/or representative of a given routing policy, is obtained. In one embodiment of the disclosure, the routing policy code may include one or more routing policy functions—each of which may be defined by an ordered list (or sequence) of routing policy statements.

The remaining steps described hereinafter may be performed for each routing policy function specified in the routing policy code (obtained in Step 402). Further, each iteration of the remaining steps, pertaining to a given routing policy function, may either be performed serially or in parallel.

In Step 404, a determination is made as to whether the new state list (created/initialized in Step 400 or updated in Steps 422 or 430) includes an entry associated with the given routing policy function. The determination may entail performing a search for an entry in the new state list that references a given name of the given routing policy function. In one embodiment of the disclosure, if it is determined that none of the existing entries (if any) of the new state list associates with the given routing policy function, then the method proceeds to Step 406. On the other hand, in another embodiment of the disclosure, if it is alternatively determined that a given existing entry of the new state list associates with the given routing policy function, then the method alternatively proceeds to Step 408.

In Step 406, following the determination (in Step 404) that the new state list excludes an entry associated with the given routing policy function, a collection of data structures is derived, for the given routing policy function, from the ordered list (or sequence) of routing policy statements thereof. In one embodiment of the disclosure, the aforementioned collection of data structures may include, but is not limited to, a new abstract evaluation tree (see e.g., FIG. 8B or 8F), a new used route attribute list (see e.g., FIG. 8C or 8G), and a new set of used external construct key vectors (see e.g., FIG. 8D or 8H). Elaboration on the derivation of the aforementioned collection of data structures are detailed in FIG. 5, below. From here, the method proceeds to Step 420 (see e.g., FIG. 4B).

In Step 408, following the alternative determination (in Step 404) that the new state list includes a given existing entry associated with the given routing policy function, another determination is made as to whether at least one other routing policy function, of the given routing policy, remains to be processed. In one embodiment of the disclosure, if it is determined that at least another routing policy function remains to be processed, then the method proceeds to Step 410. On the other hand, in another embodiment of the disclosure, if it is alternatively determined that no more routing policy functions, of the given routing policy, remains to be processed, then the method ends.

In Step 410, following the determination (in Step 408) that at least one routing policy function, of the given routing policy, remains to be processed, a next routing policy function of the aforementioned at least one remaining routing policy function is processed. In one embodiment of the disclosure, in processing the next routing policy function, the method proceeds to Step 404 (described above).

Turning to FIG. 4B, in Step 420, a determination is made as to whether a tree mounting object (TMO) (see e.g., FIG. 2B) includes an entry associated with the given routing policy function. The determination may entail performing a search for an entry in the TMO that references a given name of the given routing policy function. In one embodiment of the disclosure, if it is determined that none of the existing entries (if any) of the TMO associates with the given routing policy function, then the method proceeds to Step 422. On the other hand, in another embodiment of the disclosure, if it is alternatively determined that a given existing entry of the TMO associates with the given routing policy function, then the method alternatively proceeds to Step 424.

In Step 422, following the determination (in Step 420) that the TMO excludes an entry associated with the given routing policy function, a new entry is created in the new state list (created/initialized in Step 400 or updated in Steps 422 or 430), which references the given routing policy function. In one embodiment of the disclosure, the new entry may include, but is not limited to, the collection of data structures (described above) for the given routing policy function (derived in Step 406).

Hereinafter, the method proceeds to Step 408 (described above).

In Step 424, following the alternative determination (in Step 420) that the TMO includes a given existing entry associated with the given routing policy function, an existing abstract evaluation tree, for the given routing policy function, is identified from the aforementioned given existing entry in the TMO. In one embodiment of the disclosure, the existing abstract evaluation tree may be identified as the data object mounted to the mount point specified within the given existing entry.

In Step 426, a determination is made as to whether the new abstract evaluation tree (derived in Step 406) and the existing abstract evaluation tree (identified in Step 424), for the given routing policy function, match. The determination may entail traversing or walking the new and existing abstract evaluation trees in parallel, thereby engaging in node-by-node comparisons there-between. Through this deep comparison of the new and existing abstract evaluation trees, only select routing policy function(s) that have experienced changes is/are detected and used in the re-evaluation of one or more network routes. Further, by re-evaluating network routes using just the select routing policy function(s), rather than all the routing policy functions representative of a network routing policy, extensive churn, which would have been caused by the latter, is substantially reduced. Should at least one of the nodes of the new abstract evaluation tree mismatch a corresponding node of the existing abstract evaluation tree (or vice versa), then the new and existing abstract evaluation trees mismatch. Otherwise, should none of the nodes of the new abstract evaluation tree mismatch their corresponding nodes in the existing abstract evaluation tree (or vice versa), then the new and existing abstract evaluation trees match. Accordingly, in one embodiment of the disclosure, if it is determined that the new and existing abstract evaluation trees match, then the method proceeds to Step 428. On the other hand, in another embodiment of the disclosure, if it is alternatively determined that the new and existing abstract evaluation trees mismatch, then the method alternatively proceeds to Step 422 (described above).

In Step 428, following the determination (in Step 426) that the new abstract evaluation tree (derived in Step 406) and the existing abstract evaluation tree (identified in Step 424), for the given routing policy function, match, the collection of data structures (described above) for the given routing policy function (derived in Step 406) is discarded.

In Step 430, a new entry is created in the new state list (created/initialized in Step 400 or updated in Steps 422 or 430), which references the given routing policy function. In one embodiment of the disclosure, the new entry may include, but is not limited to, a pointer to (or a reference to a memory location storing) the given existing entry, referencing the given routing policy function, in the TMO. Hereinafter, the method proceeds to Step 408 (described above).

FIG. 5 shows a flowchart describing a method for deriving a collection of data structures in accordance with one or more embodiments of the disclosure. The various steps outlined below may be performed by the routing policy agent (see e.g., FIG. 1). Further, while the various steps in the flowcharts are presented and described sequentially, one of ordinary skill will appreciate that some or all steps may be executed in different orders, may be combined or omitted, and some or all steps may be executed in parallel.

Turning to FIG. 5, in Step 500, an ordered list (or sequence) of routing policy statements, defining a given routing policy function, is processed to obtain a token stream. In one embodiment of the disclosure, processing of the ordered list of routing policy statements may involve lexical analysis.

In Step 502, the token stream (obtained in Step 500) is subsequently parsed, which may substantively entail syntax analysis, to obtain a parse tree representative of the given routing policy function. Thereafter, in Step 504, the parse tree (obtained in Step 502) is traversed, thereby producing an abstract syntax tree for the given routing policy function.

In Step 506, the abstract syntax tree (produced in Step 504) is subsequently traversed to obtain an annotated abstract syntax tree and a symbols table, which map to the given routing policy function. From here, in Step 508, a set of type enforcement rules is enforced for exception detection and/or handling.

Lastly, in Step 510, the annotated abstract syntax tree (obtained in Step 506), is traversed to obtain—for the given routing policy function—a collection of data structures. In one embodiment of the disclosure, the collection of data structures may include, but is not limited to, a new abstract evaluation tree (see e.g., FIG. 8B or 8F), a new used route attribute list (see e.g., FIG. 8C or 8G), and a new set of used external construct key vectors (see e.g., FIG. 8D or 8H).

Furthermore, in one embodiment of the disclosure, traversal of the annotated abstract syntax tree (in Step 510) may lead to updates to a new state list (described above) (see e.g., FIGS. 4A and 4B). Specifically, the new state list may be updated to include one or more new entries for temporarily or transitively storing a most current state (in terms of one or more collections, respectively, of data structures) of a given routing policy that specifies the given routing policy function.

FIG. 6 shows a flowchart describing a method for updating a tree mounting object in accordance with one or more embodiments of the disclosure. The various steps outlined below may be performed by the routing policy agent (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 6, in Step 600, a tree mounting object (TMO) (described above) (see e.g., FIG. 2B) is searched to identify a set of routing policy functions—i.e., a first function set—each having or associated with an existing entry in the TMO.

In Step 602, a new state list (described above) (see e.g. FIGS. 4A and 4B) is searched to identify another set of routing policy functions—i.e., a second function set—each having or associated with an existing entry in the new state list.

In Step 604, a set difference between the first function set (identified in Step 600) and the second function set (identified in Step 602) is performed to obtain a third function set. In one embodiment of the disclosure, the set difference may refer to a set theory operation entailing two sets of elements, where the resulting set of elements include all elements in a first set that are not in a second set. Accordingly, the aforementioned third function set may include any routing policy functions included in the first function set yet excluded from the second function set.

In Step 606, for each routing policy function specified in the third function set (obtained in Step 604), an existing entry in the TMO, referencing the routing policy function, is removed therefrom.

The remaining steps described hereinafter may be performed for each existing entry in the above-mentioned new state list. Further, each iteration of the remaining steps, pertaining to a given existing new state list entry, may either be performed serially or in parallel.

In Step 608, a determination is made as to whether the given existing new state list entry includes a pointer to one of the existing/remaining entries in the TMO— i.e., a given existing TMO entry. The determination may entail examining the given existing new state list entry. In one embodiment of the disclosure, if it is determined that the given existing new state list entry includes said pointer, then the method proceeds to Step 610. On the other hand, in another embodiment of the disclosure, if it is alternatively determined that the given existing new state list entry excludes said pointer, then the method alternatively proceeds to Step 614.

In Step 610, following the determination (in Step 608) that the above-mentioned given existing new state list entry includes a pointer to a given existing TMO entry, a new determination is made as to whether any other existing new state list entries remain to be processed. In one embodiment of the disclosure, if it is determined that at least one other existing new state list entry remains to be processed, then the method proceeds to Step 612. On the other hand, in another embodiment of the disclosure, if it is alternatively determined that no other existing new state list entries remain to be processed, then the method alternatively ends.

In Step 612, following the determination (in Step 610) that at least one other existing new state list entry remains to be processed, a next existing new state list entry, of the aforementioned at least one other existing new state list entry remaining, is processed. In one embodiment of the disclosure, in processing the next existing new state list entry, the method proceeds to Step 608 (described above).

In Step 614, following the alternative determination (in Step 608) that the above-mentioned given existing new state list entry excludes a pointer to a given existing TMO entry, a new determination is made as to whether the given existing new state list entry references a routing policy function—i.e., a given routing policy function—that is also referenced by the given existing TMO entry. The new determination may entail examining both the given existing new state list entry and the given existing TMO entry. In one embodiment of the disclosure, if it is determined that both the given existing new state list entry and the given existing TMO entry reference the given routing policy function, then the method proceeds to Step 616. On the other hand, in another embodiment of the disclosure, if it is alternatively determined that the given existing new state list entry does not reference a routing policy function referenced by the given existing TMO entry, then the method alternatively proceeds to Step 618.

In Step 616, following the determination (in Step 614) that both the given existing new state list entry and the given existing TMO entry reference the given routing policy function, the given existing TMO entry is updated. Specifically, in one embodiment of the disclosure, at least the existing collection of data structures (e.g., existing abstract evaluation tree, existing used route attribute list, and existing set of used external construct key vectors) found in the given existing TMO entry may be replaced with content temporarily or transitively stored in the given existing new state list entry. The aforementioned content may include, but is not limited to, a new abstract evaluation tree, a new used route attribute list, and a new set of used external construct key vectors—all associated with, and derived from the ordered list (or sequence) of routing policy statements defining, the given routing policy function (see e.g., FIG. 5).

In one embodiment of the disclosure, following the above-mentioned update of the given existing TMO entry, a notification per new abstract evaluation tree may be submitted to each of the any number of routing protocol agents executing on the network device. The aforementioned notification may suggest (or otherwise instruct) the routing protocol agent(s) to re-evaluate any network routes that had relied upon the existing abstract evaluation tree(s) for the given routing policy, where at least one of the existing abstract evaluation tree(s) may be replaced with the new abstract evaluation tree.

From here, the method proceeds to Step 610 (described above).

In Step 618, following the alternative determination (in Step 614) that the given existing new state list entry does not reference a routing policy function referenced by the given existing TMO entry, a new TMO entry is created, which references the given routing policy function. In one embodiment of the disclosure, the new TMO entry may be populated with at least the content temporarily or transitively stored in the given existing new state list entry. The aforementioned content may include, but is not limited to, a new abstract evaluation tree, a new used route attribute list, and a new set of used external construct key vectors—all associated with, and derived from the ordered list (or sequence) of routing policy statements defining, the given routing policy function (see e.g., FIG. 5).

In one embodiment of the disclosure, following the above-mentioned creation of the new TMO entry, a notification per new abstract evaluation tree may be submitted to each of the any number of routing protocol agents executing on the network device. The aforementioned notification may suggest (or otherwise instruct) the routing protocol agent(s) to re-evaluate any network routes that had relied upon the existing abstract evaluation tree(s) for the given routing policy, where at least one of the existing abstract evaluation tree(s) may be replaced with the new abstract evaluation tree.

From here, the method proceeds to Step 610 (described above).

FIGS. 7A and 7B show flowcharts describing a method for route evaluation in accordance with one or more embodiments of the disclosure. The various steps outlined below may be performed by any routing protocol agent (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 7A, in Step 700, a protocol update message is received from a neighbor network device. In one embodiment of the disclosure, the protocol update message may represent a network route advertisement, or one or more network traffic data units (e.g., frame(s), packet(s), etc.) used by peers of a given routing protocol to distribute routing information pertinent to a network route. Further, the protocol update message may include one or more name-value pairs, definitive of one or more route attributes, respectively, for a given network route.

In Step 702, a current (or global) state namespace is created. Subsequently, in Step 704, the current/global state namespace (created in Step 702) is populated using the name-value pair(s) for the route attribute(s) specified in the protocol update message (received in Step 700). Thereafter, in Step 706, the current/global namespace (populated in Step 704) is enclosed within a context data object (CDO), which may be associated with the given network route.

In Step 708, one or more abstract evaluation trees, representative of a routing policy, is/are obtained from the routing policy agent on the network device (see e.g., FIG. 1). In one embodiment of the disclosure, the routing policy may generally represent any scheme through which a network route may be assessed, an action concerning the network route may be taken, and/or value(s) pertaining to one or more route attributes may be modified. By way of a more specific example, the routing policy may represent any scheme through which a network route may be selected for installation into a RIB of the network device. Further, each obtained abstract evaluation tree may refer to a hierarchical structure that serves as an efficient representation of a given routing policy function, declared in routing policy code of the routing policy, for runtime evaluation.

Hereinafter, a first subset of the remaining steps (i.e., Steps 710 through 730) may be performed for each abstract evaluation tree of the one or more abstract evaluation trees (obtained in Step 708). Further, each iteration of the first subset of the remaining steps, pertaining to a given abstract evaluation tree, may either be performed serially or in parallel.

In Step 710, a set of used external construct key vectors (see e.g., FIG. 3A), derived alongside the given abstract evaluation tree and found in an existing entry of a tree mounting object (TMO) (see e.g., FIG. 2B) referencing the given routing policy function, is identified. In one embodiment of the disclosure, each used external construct key vector, of the set of used external construct key vectors, may encompass a data structure (e.g., array) that includes one or more data entries (or key vector elements). Further, each key vector element may pertain to or may be associated with a unique external construct (described above) (see e.g., FIG. 2B) of a given construct type (e.g., prefix list, community list, autonomous system (AS)-path access list, etc.) used or recited within the given routing policy function. Accordingly, the set of used external construct key vectors may include, but is not limited to, a first used external construct key vector configured to track unique Internet Protocol version 4 (IPv4) prefix list names used or recited within the given routing policy function; a second used external construct key vector configured to track unique Internet Protocol version 6 (IPv6) prefix list names used or recited within the given routing policy function; a third used external construct key vector configured to track unique community list names used or recited within the given routing policy function; a fourth used external construct key vector configured to track unique autonomous system (AS)-path access list names used or recited within the given routing policy function; and so forth.

Hereinafter, a second subset of the remaining steps (i.e., Steps 712 through 726) may be performed for each used external construct key vector (identified in Step 710). Further, each iteration of the second subset of the remaining steps, pertaining to a given used external construct key vector, may either be performed serially or in parallel.

In Step 712, a used external construct value vector (see e.g., FIG. 3B) is created and/or initialized. In one embodiment of the disclosure, the used external construct value vector may be created and/or initialized to include the same size (or number of vector elements as the given used external construct key vector), and may be associated with or mapped to the given abstract evaluation tree. Further, each vector element, of the given used external construct key vector, may include or may be referenced by a different index.

Hereinafter, a third subset of the remaining steps (i.e., Steps 714 through 722) may be performed for each index, of a set of indices referencing a set of key vector elements of the given used external construct key vector. Further, each iteration of the third subset of the remaining steps, pertaining to a given index, may either be performed serially or in parallel.

In Step 714, from a key vector element of the given used external construct key vector, which is referenced by the given index, a construct name stored therein is obtained. In one embodiment of the disclosure, the construct name may represent any arbitrary-length character string (e.g., including letters, numbers, symbols, or any combination thereof) by which a given unique external construct (of a given construct type), used or recited within the given routing policy function, may be referred or labeled. From here, the method proceeds to Step 720 (see e.g., FIG. 7B).

Turning to FIG. 7B, in Step 720, a lookup is performed amongst entries in a system database (maintained on or otherwise accessible to the network device via a network) using the construct name (obtained in Step 714) to obtain a construct value respective to the above-mentioned given unique external construct. In one embodiment of the disclosure, the system database may refer to a distributed database configured to store, among other information, network state information pertinent to the configuration and/or operation of one or more network devices, including the network device. Furthermore, the construct value may depend on the construct type (e.g., prefix list, community list, autonomous system (AS)-path access list, etc.) with which the given used external construct key vector and the used external construct value vector (created and/or initialized in Step 712) may be associated. Accordingly, by way of an example, should the construct type reference prefix lists, the construct value may reveal a set of network prefixes (or alternatively, a wildcard value) that may be used in comparison or match operations against a network prefix for a given network route undergoing evaluation.

In Step 722, the construct value (obtained in Step 720) is subsequently stored within a value vector element of the used external construct value vector (created and/or initialized in Step 712), which is referenced by the given index. In one embodiment of the disclosure, above-described Steps 712 through 722 may be referred to as a late-binding between corresponding used external construct key and value vectors of a given construct type.

In one embodiment of the disclosure, binding may generally refer to the association of a variable name for a variable (e.g., an external construct) to a corresponding variable value, of the variable, maintained in an allocated storage location. Through conventional (i.e., non-late) binding, a variable value pre-exists in storage when the variable name, referencing the variable value, undergoes interpretation and resolution during runtime. Conventional binding, however, raises a challenge when evaluating network routes using abstract evaluation trees that may reference external constructs. Specifically, because any external construct(s) is/are configured independently of the network route evaluation runtime, interpretation of said external construct(s), during runtime, would involve time- and resource-expensive lookup operations based on the external construct name(s). In addition to these lookup operations, resolution of the external construct name(s), during evaluation runtime, would require the creation of an abstract evaluation tree clone for each abstract evaluation tree applied in the evaluation of a network route. The abstract evaluation tree clone(s), in turn, would subsequently include node(s) reflective of unbound external construct(s), which would need to be resolved through said expensive lookup operations while the abstract evaluation tree clone(s) is/are used during a network route evaluation. The solution to the aforementioned issues thus involves the application of external construct late-binding, which facilitates the resolution of external construct name(s), efficiently during evaluation runtime, without the need to create any abstract evaluation tree clone(s).

In Step 724, a determination is made as to whether any index (or indices), referencing any other key vector elements of the given used external construct key vector, remains to be processed. In one embodiment of the disclosure, if it is determined that at least one index remains to be processed, then the method proceeds to Step 726. On the other hand, in another embodiment of the disclosure, if it is alternatively determined that no more indices remain to be processed, then the method alternatively proceeds to Step 728.

In Step 726, following the determination (in Step 724) that at least one other index, of the given used external construct key vector, remains to be processed, a next index, of the given used external construct key vector, is processed. In one embodiment of the disclosure, in processing the next index, the method proceeds to Step 712 (described above).

In Step 728, following the alternative determination (in Step 724) that no more indices, of the given used external construct key vector, remains to be processed, a new determination is made as to whether any other abstract evaluation trees (obtained in Step 708) for the routing policy remain to be processed. In one embodiment of the disclosure, if it is determined that at least one other abstract evaluation tree remains to be processed, then the method proceeds to Step 730. On the other hand, in another embodiment of the disclosure, if it is alternatively determined that no other abstract evaluation trees remain to be processed, then the method alternatively proceeds to Step 732.

In Step 730, following the determination (in Step 728) that at least one other abstract evaluation tree (obtained in Step 708) for the routing policy remains to be processed, a next abstract evaluation tree, for the routing policy, is processed. In one embodiment of the disclosure, in processing the next abstract evaluation tree, the method proceeds to Step 710 (described above).

In Step 732, following the alternative determination (in Step 728) that no other abstract evaluation trees (obtained in Step 708) for the routing policy remain to be processed, the abstract evaluation tree(s) (obtained in Step 708) is/are subsequently traversed, using the CDO (obtained in Step 706) and the set of used external construct value vectors (created/populated in Steps 712 through 726), to derive a tri-state route evaluation for the given network route. In one embodiment of the disclosure, the traversal of the abstract evaluation tree(s) may entail the processing of one or more nodes, stemming from the root node of each abstract evaluation tree, in conjunction with actions (e.g., route attribute value modifications) that may be applied to the CDO as a result of the aforementioned processing.

In Step 734, based on the tri-state route evaluation (derived in Step 732), a route action is performed or taken on the given network route. Specifically, in one embodiment of the disclosure, the route action may either permit or deny installation of the given network route into the RIB of the network device.

FIG. 8A shows an exemplary routing policy code in accordance with one or more embodiments of the disclosure. The exemplary routing policy code (800) includes two routing policy functions (802)—a primary routing policy function named routine and a secondary routing policy function named subroutine. Further, each of the routing policy functions (802) specify their own respective ordered list of routing policy statements (804).

FIG. 8B shows an exemplary abstract evaluation tree in accordance with one or more embodiments of the disclosure. Specifically, the conveyed exemplary abstract evaluation tree (810) captures the hierarchical representation of the ordered list of routing policy statements for the primary routing policy function, named routine, shown in FIG. 8A.

FIG. 8C shows an exemplary used route attribute list in accordance with one or more embodiments of the disclosure. Specifically, the conveyed exemplary used route attribute list (812) captures the unique route attributes used or recited throughout the primary routing policy function, named routine, shown in FIG. 8A.

FIG. 8D shows exemplary used external construct key vectors in accordance with one or more embodiments of the disclosure. Specifically, the conveyed exemplary used external construct key vectors (814)—associated with the primary routing policy function, named routine and shown in FIG. 8A—includes, but is not limited to, a first used external construct key vector (814A) respective to Internet Protocol version 4 network prefix lists and a second used external construct key vector (814B) respective to Internet Protocol version 6 network prefix lists. Further, though not shown, the conveyed exemplary used external construct key vectors (814) may include one or more other used external construct key vectors respective to one or more other construct types—e.g., community lists, autonomous system (AS)-path access lists, etc. Also, one of ordinary skill will appreciate that any exemplary used external construct key vector (814) may include less than or more than the three data entries shown associated therewith.

Concerning the first used external construct key vector (814A), various data entries are illustrated. In a first data entry, a construct name (i.e., PList) for a list of Internet Protocol version 4 network prefixes maps to or references a first index [0]. The remaining data entries, though referencing a second index [1] and a third index [2], remain empty as initialized (without respective construct names). Similarly, concerning the second used external construct key vector (814B), various data entries are also illustrated. Further, each of the data entries of the second used external construct key vector (814B), though mapping to or referencing a respective index—i.e., [0], [1], [2]—is empty as initialized.

FIG. 8E shows exemplary used external construct value vectors in accordance with one or more embodiments of the disclosure. Specifically, the conveyed exemplary used external construct value vectors (816)—associated with the primary routing policy function, named routine and shown in FIG. 8A—includes, but is not limited to, a first used external construct value vector (816A) respective to Internet Protocol version 4 network prefix lists and a second used external construct value vector (816B) respective to Internet Protocol version 6 network prefix lists. Further, though not shown, the conveyed exemplary used external construct value vectors (816) may include one or more other used external construct key vectors respective to one or more other construct types—e.g., community lists, autonomous system (AS)-path access lists, etc. Also, one of ordinary skill will appreciate that any exemplary used external construct value vector (816) may include less than or more than the three data entries shown associated therewith.

Concerning the first used external construct value vector (816A), various data entries each associated with a different index—e.g., [0], [1], [2]—is illustrated. Further, in a first data entry, addressed by a first index [0], a construct value (i.e., [172.16.10.1/32; 172.16.10.32/27; 172.16.10.50/32; 172.16.10.96/29; 172.16.10.104/29; 172.16.10.128/27]) for a list of Internet Protocol version 4 network prefixes is referenced. Note that the aforementioned construct value, referenced by a first index [0], maps to the above-mentioned construct name PList also referenced by the same first index [0]. The remaining data entries, addressed by a second index [1] and a third index [2], remain empty as initialized. Similarly, concerning the second used external construct value vector (816B), various data entries each associated with a different index—e.g., [0], [1], [2]—is illustrated. Each of the data entries of the second used external construct value vector (816B), however, is empty as initialized.

FIG. 8F shows an exemplary abstract evaluation tree in accordance with one or more embodiments of the disclosure. Specifically, the conveyed exemplary abstract evaluation tree (820) captures the hierarchical representation of the ordered list of routing policy statements for the secondary routing policy function, named subroutine, shown in FIG. 8A.

FIG. 8G shows an exemplary used route attribute list in accordance with one or more embodiments of the disclosure. Specifically, the conveyed exemplary used route attribute list (822) captures the unique route attributes used or recited throughout the secondary routing policy function, named subroutine, shown in FIG. 8A.

FIG. 8H shows exemplary used external construct key vectors in accordance with one or more embodiments of the disclosure. Specifically, the conveyed exemplary used external construct key vectors (824)—associated with the secondary routing policy function, named subroutine and shown in FIG. 8A—includes, but is not limited to, a first used external construct key vector (824A) respective to Internet Protocol version 4 network prefix lists and a second used external construct key vector (824B) respective to Internet Protocol version 6 network prefix lists. Further, though not shown, the conveyed exemplary used external construct key vectors (824) may include one or more other used external construct key vectors respective to one or more other construct types—e.g., community lists, autonomous system (AS)-path access lists, etc. Also, one of ordinary skill will appreciate that any exemplary used external construct key vector (824) may include less than or more than the three data entries shown associated therewith.

Concerning the first used external construct key vector (824A), various data entries are illustrated. Further, though mapping to or referencing a respective index—i.e., [0], [1], [2]—each data entry remains empty as initialized (without a respective construct name) Similarly, concerning the second used external construct key vector (824B), various data entries are also illustrated, where each of the data entries of the second used external construct key vector (824B), though referencing a respective index—i.e., [0], [1], [2]—is also empty as initialized.

FIG. 8I shows exemplary used external construct value vectors in accordance with one or more embodiments of the disclosure. Specifically, the conveyed exemplary used external construct value vectors (826)—associated with the secondary routing policy function, named subroutine and shown in FIG. 8A—includes, but is not limited to, a first used external construct value vector (826A) respective to Internet Protocol version 4 network prefix lists and a second used external construct value vector (826B) respective to Internet Protocol version 6 network prefix lists. Further, though not shown, the conveyed exemplary used external construct value vectors (826) may include one or more other used external construct key vectors respective to one or more other construct types—e.g., community lists, autonomous system (AS)-path access lists, etc. Also, one of ordinary skill will appreciate that any exemplary used external construct value vector (826) may include less than or more than the three data entries shown associated therewith.

Concerning the first used external construct value vector (826A), various data entries each associated with a different index—e.g., [0], [1], [2]—is illustrated. Further, all data entries are empty as initialized. Similarly, concerning the second used external construct value vector (826B), various data entries each associated with a different index—e.g., [0], [1], [2]—is illustrated, where each of the data entries of the second used external construct value vector (826B) is also empty as initialized.

In the above description, numerous details are set forth as examples of embodiments described herein. It will be understood by those skilled in the art, and having the benefit of this Detailed Description, that one or more embodiments of embodiments described herein may be practiced without these specific details and that numerous variations or modifications may be possible without departing from the scope of the embodiments described herein. Certain details known to those of ordinary skill in the art may be omitted to avoid obscuring the description.

In the above description of the figures, any component described with regard to a figure, in various embodiments described herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A network device, the network device comprising:
a computer processor;
a routing policy agent executing on the computer processor; and
a routing protocol agent operatively connected to the routing policy agent and also executing on the computer processor,
wherein the routing policy agent is configured to perform a first method directed to compiling routing policies, the first method comprising:
obtaining, for a routing policy, routing policy code comprising at least one routing policy function;
for each routing policy function of the at least one routing policy function:
identifying an ordered list of routing policy statements forming the routing policy function;
processing the ordered list of routing policy statements using lexical analysis to obtain a token stream;
parsing the token stream using syntax analysis to obtain a parse tree;
traversing the parse tree to obtain an abstract syntax tree;
traversing the abstract syntax tree to obtain an annotated abstract syntax tree; and
traversing the annotated abstract syntax tree to obtain an abstract evaluation tree,
wherein the routing protocol agent is configured to perform a second method directed to evaluating a network route, the second method comprising:
obtaining at least one abstract evaluation tree representing the routing policy;
obtaining a context data object (CDO) associated with the network route;
traversing, using the CDO, the at least one abstract evaluation tree to derive a route evaluation for the network route; and
performing a route action to the network route based on the route evaluation.

2. The network device of claim 1, the network device further comprising:
memory operatively connected to the computer processor, and comprising a routing information base (RIB),
wherein the route action comprises programming the RIB to include the network route, or discarding the network route.

3. The network device of claim 1, wherein the network device is a switch, a router, or a multilayer switch.

4. A method for evaluating network routes, the method comprising:
obtaining a routing policy;
obtaining at least one abstract evaluation tree representing the routing policy;
obtaining a context data object (CDO) associated with a network route; and
traversing, using the CDO, the at least one abstract evaluation tree to derive a route evaluation for the network route.

5. The method of claim 4, wherein each abstract evaluation tree of the at least one abstract evaluation tree comprises a directed graph sequencing operations to be performed on or using the CDO.

6. The method of claim 4, wherein each abstract evaluation tree of the at least one abstract evaluation tree represents an implementation of a routing policy function of the routing policy.

7. The method of claim 4, wherein the CDO comprises a set of route attribute names mapped to a set of route attribute values, respectively, descriptive of the network route.

8. The method of claim 7, wherein traversing the at least one abstract evaluation tree further modifies at least one route attribute value of the set of route attribute values.

9. The method of claim 7, wherein to traverse the at least one abstract evaluation tree, the method further comprises:
arriving at a branch node of the at least one abstract evaluation tree,
wherein the branch node reflects a comparison operation and wherein processing the comparison operation using the CDO, comprises:
following a first edge from the branch node to a first leaf node, wherein the first leaf node reflects a route attribute name of the set of route attribute names;
following a second edge from the branch node to a second leaf node, wherein the second leaf node reflects a construct type and a construct name for an external construct;
identifying, in the CDO, a route attribute value of the set of route attribute values, wherein the route attribute value maps to the route attribute name;
identifying, associated with the at least one abstract evaluation tree, a used external construct key vector and a used external construct value vector both respective to the construct type;
performing a first lookup on the used external construct key vector using the construct name to obtain an index; and
performing a second lookup on the used external construct value vector using the index to obtain a construct value for the external construct.

10. The method of claim 9, wherein the route attribute value reflects a network prefix associated with the network route, and the construct value for the external construct comprises a list of network prefixes.

11. The method of claim 9, wherein the route attribute value reflects a community associated with the network route, and the construct value for the external construct comprises a list of communities.

12. The method of claim 9, wherein the route attribute value reflects an autonomous system (AS) path associated with the network route, and the construct value for the external construct comprises an access list of AS paths.

13. The method of claim 9, the method further comprising:
prior to traversing the at least one abstract evaluation tree:
late-binding the used external construct value vector with the used external construct key vector, the late-binding comprising:
for each given construct name of a set of given construct names stored along the used external construct key vector:
performing a third lookup in a system database using the given construct name to obtain a given construct value;
performing a fourth lookup on the used external construct key vector using the given construct name to obtain a given index; and
storing the given construct value within a value vector element of the used external construct value vector,
wherein the value vector element is referenced by the given index.

14. The method of claim 4, the method further comprising:
performing, to the network route, a route action based on the route evaluation,
wherein the route action comprises programming a route information base (RIB) to include the network route.

15. The method of claim 4, the method further comprising:
performing, to the network route, a route action based on the route evaluation,
wherein the route action comprises discarding the network route.

16. A method for compiling routing policies, the method comprising:
obtaining routing policy code comprising at least one routing policy function;
for each routing policy function of the at least one routing policy function:
identifying an ordered list of routing policy statements forming the routing policy function;
processing the ordered list of routing policy statements using lexical analysis to obtain a token stream;
parsing the token stream using syntax analysis to obtain a parse tree;
traversing the parse tree to obtain an abstract syntax tree;
traversing the abstract syntax tree to obtain an annotated abstract syntax tree; and
traversing the annotated abstract syntax tree to obtain a new abstract evaluation tree.

17. The method of claim 16, wherein traversing the annotated abstract syntax tree further obtains a new used route attribute list and a new set of used external construct key vectors pertinent to the routing policy function.

18. The method of claim 17, the method further comprising:
for each routing policy function of the at least one routing policy function:
making a determination that a tree mounting object excludes an entry referencing the routing policy function; and
updating, based on the determination, a new state list to include a new entry for the routing policy function,
wherein the new entry comprises the new abstract evaluation tree, the new used route attribute list, and the new set of used external construct key vectors pertinent to the routing policy function.

19. The method of claim 17, the method further comprising:
for each routing policy function of the at least one routing policy function:
making a first determination that a tree mounting object includes an entry referencing the routing policy function;
identifying, based on the first determination, an existing abstract evaluation tree specified in the entry of the tree mounting object;
making a second determination that the new abstract evaluation tree mismatches the existing abstract evaluation tree; and
updating, based on the second determination, a new state list to include a new entry for the routing policy function,
wherein the new entry comprises the new abstract evaluation tree, the new used route attribute list, and the new set of used external construct key vectors pertinent to the routing policy function.

20. The method of claim 17, the method further comprising:
for each routing policy function of the at least one routing policy function:
making a first determination that a tree mounting object includes an entry referencing the routing policy function;
identifying, based on the first determination, an existing abstract evaluation tree specified in the entry of the tree mounting object;
making a second determination that the new abstract evaluation tree matches the existing abstract evaluation tree;
based on the second determination:
discarding the new abstract evaluation tree, the new used route attribute list, and the new set of used external construct key vectors pertinent to the routing policy function; and
updating a new state list to include a new entry for the routing policy function,
wherein the new entry comprises a pointer to the entry of the tree mounting object.
